(19) United States
(12) Patent Application Publication
(10) Pub. No.: US 2026/0251927 A1
(43) Pub. Date: Aug. 27, 2026

(54) EFFICIENT OPTICAL MODULATORS

(71) Applicant: HyperLight Corporation, Cambridge, MA (US)

(72) Inventors: Lingfei Zhao, Cambridge, MA (US); Jeffrey Cole Holzgrafe, Lexington, MA (US); Mian Zhang, Cambridge, MA (US); Sean P. Anderson, Macungie, PA (US); Amirmahdi Honardoost, Somerville, MA (US); Fan Ye, Lincoln, MA (US)

(21) Appl. No.: 19/548,858

(22) Filed: Feb. 24, 2026

Related U.S. Application Data
(60) Provisional application No. 63/763,148, filed on Feb. 25, 2025.
(60) Provisional application No. 63/842,603, filed on Jul. 11, 2025.

(51) Int. Cl. G02F 1/035

(52) U.S. Cl. CPC G02F 1/035; G02B 6/12; G02F 1/0316; G02B 2006/1204; G02B 2006/12045; G02B 2006/12097; G02B 2006/12142

(57) ABSTRACT

An electro-optic device including an optical modulator is described. The optical modulator includes a waveguide and electrodes. The waveguide includes thin film lithium-containing (TFLC) material(s). The waveguide may include a ridge and a slab in at least a modulation region. A portion of the electrodes are proximate to part of the waveguide in the modulation region. At least one of: an electrode has contour(s) such that a first portion of the electrode is proximate to a sidewall and a second portion of the electrode is proximate to a top surface of the ridge and/or the slab; at least a portion of the electrode includes a transparent conductive material; and/or the optical modulator is configured such that a velocity match between an electrode signal speed of an electrode signal in the electrode and an optical speed of an optical signal in the waveguide is detuned to provide a velocity mismatch.

### CROSS REFERENCE TO OTHER APPLICATIONS

This application claims priority to U.S. Provisional Patent Application No. 63/763,148 entitled EFFICIENT OPTICAL MODULATOR filed Feb. 25, 2025 and U.S. Provisional Patent Application No. 63/842,603 entitled LOW VPIL OPTICAL MODULATORS filed Jul. 11, 2025, both of which are incorporated herein by reference for all purposes.

### BACKGROUND OF THE INVENTION

Lithium-containing (LC) electro-optic materials may be desired to be used in optical devices such as photonics integrated circuits (PICs). Thin film lithium-containing (TFLC) materials may include materials such as thin film LN (TFLN) and/or thin film LT (TFLT). TFLC optical modulators may support high data rates and low losses. These characteristics are desirable in applications such as data communication and/or telecommunication. Such TFLC photonic integrated circuits (TFLC PICs) are also desired to be integrated with other components.

However, the modulation efficiency of TFLC modulators may be lower than desired. Stated differently, V-pi and/or V-pi-L may be greater than desired. To compensate for this, TFLC modulators are generally made longer. Consequently, TFLC modulators compatible with typical drive levels may be long. In some cases, the physical size of the electro-optic device (e.g., a PIC) incorporating the TFLC modulators makes it difficult to integrate the PIC into 3D packaging. Thus, improvements in TFLC modulators, such as increases in modulation efficiency and/or techniques for reducing the size of the TFLC modulators may be desired.

### BRIEF DESCRIPTION OF THE DRAWINGS

Various embodiments of the invention are disclosed in the following detailed description and the accompanying drawings.

FIG. 1 is a block diagram of an embodiment of a thin film lithium-containing electro-optic device.

FIGS. 2A-2B depict an embodiment of a portion of a thin film lithium-containing electro-optic device.

FIG. 3 depicts an embodiment of a portion of a thin film lithium-containing electro-optic device that may have improved efficiency.

FIG. 4 depicts an embodiment of a portion of a thin film lithium-containing electro-optic device that may have improved efficiency.

FIG. 5 depicts an embodiment of a portion of a thin film lithium-containing electro-optic device that may have improved efficiency.

FIG. 6 depicts an embodiment of a portion of a thin film lithium-containing electro-optic device that may have improved efficiency.

FIG. 7 depicts an embodiment of a portion of a thin film lithium-containing electro-optic device that may have improved efficiency.

FIG. 8 depicts an embodiment of a portion of a thin film lithium-containing electro-optic device that may have improved efficiency.

FIG. 9 depicts an embodiment of a portion of a thin film lithium-containing electro-optic device that may have improved efficiency.

FIG. 10 depicts an embodiment of a portion of a thin film lithium-containing electro-optic device that may have improved efficiency.

FIGS. 11A-11B depict an embodiment of a portion of a thin film lithium-containing electro-optic device that may have improved efficiency.

FIGS. 12A-12B depict an embodiment of a portion of a thin film lithium-containing electro-optic device that may have improved efficiency.

FIG. 13 depicts an embodiment of a portion of a thin film lithium-containing electro-optic device that may have improved efficiency.

FIG. 14 depicts an embodiment of a portion of a thin film lithium-containing electro-optic device that may have improved efficiency.

FIG. 15 depicts an embodiment of a portion of a thin film lithium-containing electro-optic device that may have improved efficiency.

FIG. 16 depicts an embodiment of a portion of a thin film lithium-containing electro-optic device that may have improved efficiency.

FIG. 17 depicts an embodiment of a portion of a thin film lithium-containing electro-optic device that may have improved efficiency.

FIG. 18 depicts an embodiment of a portion of a thin film lithium-containing electro-optic device that may have improved efficiency.

FIG. 19 depicts an embodiment of a portion of a thin film lithium-containing electro-optic device that may have improved efficiency.

FIG. 20 depicts an embodiment of a portion of a thin film lithium-containing electro-optic device that may have improved efficiency.

FIG. 21 depicts an embodiment of a portion of a thin film lithium-containing electro-optic device that may have improved efficiency.

FIG. 22 depicts an embodiment of a portion of a thin film lithium-containing electro-optic device that may have improved efficiency.

FIG. 23 depicts an embodiment of a portion of a thin film lithium-containing electro-optic device that may have improved efficiency.

FIG. 24 depicts an embodiment of a portion of a thin film lithium-containing electro-optic device that may have improved efficiency.

FIG. 25 depicts an embodiment of a portion of an electrode of a thin film lithium-containing electro-optic device that may have improved efficiency.

FIG. 26 depicts an embodiment of a portion of an electrode of a thin film lithium-containing electro-optic device that may have improved efficiency.

FIG. 27 depicts an embodiment of a portion of an electrode of a thin film lithium-containing electro-optic device that may have improved efficiency.

FIG. 28 depicts an embodiment of a portion of a thin film lithium-containing electro-optic device that may have improved efficiency.

FIG. 29 depicts an embodiment of a portion of a thin film lithium-containing electro-optic device that may have improved efficiency.

FIG. 30 depicts an embodiment of a portion of electrodes of a thin film lithium-containing electro-optic device that may have improved efficiency.

FIG. 31 depicts an embodiment of a portion of electrodes of a thin film lithium-containing electro-optic device that may have improved efficiency.

FIGS. 32A-32B depict embodiments of a portion of electrodes of a thin film lithium-containing electro-optic device that may have improved efficiency.

FIG. 33 is a flow chart depicting an embodiment of a method for providing a thin film lithium-containing electro-optic device that may have improved efficiency.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Thin film lithium-containing (TFLC) electro-optic materials, such as lithium niobate (LN) and/or lithium tantalate (LT), exhibit a large electro-optic effect. TFLC material(s) may, therefore, be used in electro-optic devices such as optical modulators to facilitate modulation of the optical signal. Such TFLC optical modulators may also support high data rates and low losses. These characteristics are desirable in applications such as data communication and/or telecommunication.

However, the modulation efficiency of conventional TFLC modulators may be limited, resulting in relatively long devices. Such large TFLC optical devices may be difficult to integrate into 3D packaging. Thus, improvements in TFLC modulators are still investigated. For example, improvements in electro-optic modulation efficiency and/or techniques for reducing the size of the TFLC modulators may be desired. The modulation efficiency (V-pi-L) is at least partially determined by the cross-sectional geometry of the electrodes near the waveguide. Reducing the electrode gap (i.e. moving electrodes closer together and closer to the waveguide in the modulation region) may improve efficiency. However, techniques such as reducing electrode gaps or introducing additional metal layers may increase optical loss and capacitance. This adversely affects performance of the TFLC optical device. Consequently, other mechanisms for improving the modulation efficiency while allowing for shorter modulators are desired.

Other considerations in electro-optic modulators include impedance matching and velocity matching for the electro-optic modulator. The electrodes on the electro-optic device (e.g., a PIC) are typically coupled with a driver or other electrode signal source that is off of the PIC. In order to reduce losses, impedance matching is generally used. Stated differently, the impedance of the optical modulator is generally desired to be as close as possible to the impedance of the driver (or other electrical signal source). The impedance of the electrodes is proportional to the square root of the inductance divided by the capacitance (sqrt(L/C)), where L is the inductance and C the capacitance of the electrodes. The capacitance of the electrodes includes the capacitance between electrodes on opposite sides of the waveguide. Matching the optical device impedance to the driver impedance, may limit the capacitance of the electrodes to be, e.g., less than 80-100 pF/m for each electrode pair near each waveguide. Higher capacitances may result in an impedance that is lower than desired for matching with the driver impedance, resulting in increased losses.

Another significant issue in TFLC optical modulators is the velocity mismatch between the electrode signal and the optical signal. Typically, the speed of the electrode signal in the electrodes (and through the optical medium-e.g., TFLC electro-optic material(s) and surrounding structures such as cladding) differs from the speed of the optical signal in the waveguide (e.g., the optical group velocity, also termed “optical signal speed”). This difference in the optical signal speed in the waveguide and the speed of the electrode signal (“electrode signal speed”) is known as the velocity mismatch. The velocity mismatch can cause significant losses, resulting in poorer performance than if the optical speed is the same as the electrode signal speed. Such losses may render some electro-optic modulators unusable for many applications. Losses due to the velocity mismatch are generally greater for longer modulators (i.e. modulators having a longer modulation region). In general, the optical speed in TFLC electro-optic modulators is greater than the electrode speed. Further, the electrode speed signal is proportional to the square root of the inductance multiplied by the capacitance of the electrodes (sqrt(LC)). As a result, TFLC electro-optic modulators are generally configured to reduce the velocity mismatch. Changes in the capacitance and/or inductance for the electrodes affect the impedance. Consequently, the inductance and capacitance of the electrodes are desired to be controlled to provide velocity matching and impedance matching. This may limit the inductance, capacitance, and impedances generally used.

Consequently, TFLC electro-optic modulators and other modulators are typically designed such that the velocity mismatch is reduced (e.g. less than a 1% mismatch over the modulation region) and the impedance (and thus the inductance and capacitance) are within particular ranges. However, such configurations may result in a lower modulation than desired. Stated differently, the V-pi-L (voltage required for a change in phase of pi for the optical signal multiplied by the modulation length) and V-pi (voltage required for a change in phase of pi for the optical signal) may be greater than desired. The electro-optic efficiency (e.g. V-pi-L) of TFLN modulators is difficult to increase. Increasing efficiency by placing the electrode closer fundamentally increases the capacitance of the modulator. This decreases the overall effectiveness due to a greater velocity mismatch and/or a greater impedance mismatch. Therefore, improvements are still desired.

An electro-optic device including an optical modulator is described. The optical modulator includes a waveguide and a plurality of electrodes. The waveguide includes thin film lithium-containing (TFLC) material(s). For example, the TFLC material may include or consist of thin film lithium niobate (TFLN) and/or thin film lithium tantalate (TFLT). The waveguide includes a ridge and/or a slab in at least a modulation region. A portion of the electrodes are proximate to a portion of the waveguide in the modulation region. In some embodiments, at least one of: an electrode has contour(s) such that a first portion of the electrode is proximate to a sidewall and a second portion of the electrode is proximate to a top surface of the ridge and/or the slab; at least a portion of the electrode includes a transparent conductive material; and/or the optical modulator is configured such that a velocity match between an electrode signal speed of an electrode signal in the electrode and an optical speed of an optical signal in the waveguide is detuned to provide a velocity mismatch. In some embodiments, the slab includes a trench therein.

In some embodiments, the sidewall is a slab sidewall of the slab and the top surface is a slab top surface of the slab. The electrode further includes a third portion proximate to a ridge top surface of the ridge. In some embodiments, the electrode further includes a bottom portion that extends under the slab. The bottom portion is connected to the first portion and the second portion of the electrode by at least one of conductive via(s), a channel portion of the electrode further from the waveguide, and/or a direct connection of the bottom portion. In some embodiments, the portion of the electrode includes the transparent conductive material having a dielectric constant greater than a cladding dielectric constant.

In some embodiments, the electrodes include extensions coupled with channel regions. The extensions may include or consist of transparent conductive material. The electrode may include a portion of the plurality of extensions. The first portion and the second portion of the electrode have a configuration selected from coupled to the portion of the plurality of extensions and included in the portion of the plurality of extensions.

In some embodiments, the electrodes and waveguide are configured such that the optical modulator has a V-pi-L of not more than 2 V-cm and a length of not more than 5 millimeters. In some embodiments, the electrodes include apertures therein. The electrodes may include an electrode pair. In some such embodiments, the electrode pair has a capacitance of at least 10 pF/m and not more than 90 pF/m for a gap of the electrode pair and an impedance of at least 20 Ohms and not more than 80 Ohms.

In some embodiments, the velocity mismatch is at least one percent and not more than fifty percent. In some embodiments, the velocity mismatch is at least five percent. In some such embodiments, the modulation region has a length of not more than five millimeters.

An optical modulator including a waveguide and electrodes is described. The waveguide includes at least one TFLC material. The waveguide also includes a ridge and/or a slab in at least a modulation region. Some of the electrodes are proximate to a portion of the waveguide in the modulation region. In some embodiments, at least one of: an electrode has contour(s) such that a first portion of the electrode is proximate to a sidewall and a second portion of the electrode is proximate to a top surface of the ridge and/or the slab; at least a portion of the electrode includes a transparent conductive material; and/or the optical modulator is configured such that a velocity match between an electrode signal speed of an electrode signal in the electrode and an optical speed of an optical signal in the waveguide is detuned to provide a velocity mismatch. The electrode may include a bottom portion extending under the slab. In some embodiments, the electrode includes the transparent conductive material. In some such embodiments, the transparent conductive material has a dielectric constant greater than a cladding dielectric constant. In some embodiments, the optical modulator is configured such that the velocity mismatch is at least five percent and not more than fifty percent and the modulation region has a length of not more than five millimeters.

A method for providing an electro-optic device is described. The method includes providing an optical modulator. Providing the optical modulator includes providing a waveguide and providing electrodes. The waveguide includes TFLC material(s). The waveguide also includes a ridge and/or a slab in at least a modulation region. A portion of the electrodes are proximate to a portion of the waveguide in the modulation region. Moreover, providing the optical modulator includes configuring the optical modulator such that at least one of an electrode has at least one contour such that a first portion of the electrode is proximate to a sidewall and a second portion of the electrode is proximate to a top surface of the ridge and/or the slab, at least a portion of the electrode includes a transparent conductive material, and/or the optical modulator is configured such that a velocity match between an electrode signal speed of an electrode signal in the electrode and an optical speed of an optical signal in the waveguide is detuned to provide a velocity mismatch.

An electro-optic device including an optical modulator is described. The optical modulator includes a waveguide and a plurality of electrodes. The waveguide includes thin film lithium-containing (TFLC) material(s). For example, the TFLC material may include or consist of thin film lithium niobate (TFLN) and/or thin film lithium tantalate (TFLT). The waveguide includes a ridge and/or a slab in at least a modulation region. A portion of the electrodes are proximate to a portion of the waveguide in the modulation region. In some embodiments, the electrodes are configured to enhance modulation efficiency to provide a V-pi-L of not more than 2 V-cm. This may be achieved by reducing a gap between an electrode pair to not more than 3 micrometers. Further, additional losses may be mitigated. For example, the electrode pair includes at least one of additional gap(s) between the electrodes that are greater than three micrometers, utilizing transparent conductive material(s) for at least a portion of the electrode(s), and/or detuning the velocity match for a modulation region to greater than five percent.

An electro-optic device is described. The electro-optic devices includes an optical modulator including a waveguide and a plurality of electrodes. The waveguide includes at least one TFLC material, such as TFLN and/or TFLT. The waveguide is configured to carry an optical signal having an optical speed. A portion of the electrodes are proximate to a portion of the waveguide in a modulation region. At least one of the electrodes carries an electrode signal having an electrode signal speed. The optical modulator is configured such that a velocity match between the electrode signal speed and the optical speed is detuned to provide a velocity mismatch. In some embodiments, the velocity mismatch is at least one percent and not more than fifty percent. The velocity mismatch may be at least five percent. In some embodiments, the velocity mismatch is at least ten percent. In some embodiments, the modulation region has a length of not more than 5 millimeters. In some embodiments, the length is not more than 2 millimeters. In some embodiments, the length is not more than 1 millimeters and at least 100 micrometers. In some embodiments, wherein the waveguide includes at least one of a ridge or a slab.

In some embodiments, an electrode has at least one contour such that a first portion of the electrode is proximate to a sidewall and a second portion of the electrode is proximate to a top surface of at least one of the ridge or the slab. In some embodiments, the electrode further includes a bottom portion extending under the at least one of the slab or the ridge. The bottom portion may be connected to the first portion and the second portion by at a conductive via, a channel portion of the electrode, or a direct connection of the bottom portion.

In some embodiments, a portion of the electrode includes a transparent conductive material. The transparent conductive material may have a dielectric constant greater than a cladding dielectric constant. In some embodiments, the electrodes include extensions. In some embodiments, at least a portion of the extensions includes or consists of a transparent conductive material. In some embodiments, cladding is between the waveguide and the extensions. The cladding may be an etch stop for the transparent conductive material and may have a thickness of at least 5 nanometers and more than 50 nanometers. In some embodiments, the thickness of this portion of the cladding is not more than 20 nanometers. For example, the thickness may be nominally 10-20 nanometers. In some embodiments, the extensions have a vertical location, that is higher than a bottom surface of a portion of the waveguide and lower than a top surface of the portion of the waveguide. For example, the extensions may be above the top surface of the slab (and thus above the bottom surface of the ridge) and below the top surface of the ridge. In some embodiments, the optical modulator has a V-pi-L of not more than 2 V-cm and a length of not more than 5 millimeters. In some such embodiments, the V-pi-L is not more than 1.5 V-cm and the modulation region has a length of not more than 4 millimeters. In some such embodiments, the V-pi-L is not more than 1 V-cm and the modulation region has a length of not more than 3 millimeters.

In some embodiments, the electrodes have a capacitance of at least 10 pF/m for each electrode contact around each waveguide and not more than 90 pF/m for each electrode contact around each waveguide (e.g. capacitance of at least 10 pF/m for each gap of an electrode pair and not more than 90 pF/m for each gap of the electrode pair) and an impedance of at least 20 Ohms and not more than 80 Ohms. In some embodiments, the capacitance is at least 10 pF/m and not more than 90 pF/m for each gap of the electrode pair and an impedance of at least 45 Ohms and not more than 120 Ohms. In some embodiments, the capacitance is at least 100 pF/m and not more than 500 pF/m for each gap of the electrode pair. In some embodiments, the optical propagation loss in waveguides near electrode is large (e.g., at least 1 dB/cm, at least 3 dB/cm, at least 5 dB/cm, at least 10 dB/cm, at least 20 dB/cm, at least 30 dB/cm). In some embodiments, the electrodes have a capacitance of at least 100 pF/m for each electrode contact around each waveguide and not more than 500 pF/m for each electrode contact around each waveguide. Although described as extensions, in some embodiments, some portions of the electrodes may be unstructured, or monolithic. Similarly, some electrodes depicted as unstructured electrodes may include extensions and/or other features in some embodiments.

A TFLC electro-optic device is described. In some embodiments, the TFLC electro-optic device is a TFLC photonics integrated circuit. The electro-optic device includes optical modulator(s). The optical modulator includes at least one TFLC material. In some embodiments, an optical modulator includes a waveguide and electrodes. The optical modulator may be configured as a Mach-Zehnder modulator. Thus, the waveguide may have multiple arms as well as splitters/combiners. The waveguide includes TFLC material(s) and is configured to carry an optical signal. The electrodes are configured to carry electrode signal(s) for modulating the optical signal. A portion of the waveguide is between a first electrode and a second electrode. The portion of the waveguide has a slab and/or a ridge. In some embodiments, the first and second electrodes are configured to have a first separation distance across the slab and a second separation across the ridge. The second distance is less than the first distance. In some such embodiments, the first electrode and the second electrode have third spacing less than the second spacing in a region above the ridge. In some embodiments, the first electrode and the second electrode have a third separation distance below the slab. In some embodiments, the ridge has a width of at least one micrometer and not more than four micrometers for the portion of the waveguide. The second separation distance is at least 1.5 micrometers and not more than six micrometers. In some embodiments, the slab has a width of at least 2.5 micrometers and not more than eight micrometers. The first separation distance is greater than the width of the slab. In some embodiments, the slab has at least one depression therein. The at least one depression is between the ridge and the first electrode. The depression may have a depth of not more than half of the slab+thickness. In some embodiments, the optical modulator has a V-pi-L of not more than 1 V-cm. The optical modulator may also include a cladding layer. The cladding layer may include high permittivity, low index material(s) such as hafnium oxide.

The electro-optic devices are described in the context of TFLC materials such as thin film lithium niobate (TFLN) and/or thin film lithium tantalate (TFLC). However, other materials, such as other Pockels materials, may be used. The other waveguides are described in the context of SiN and/or Si (SiN/Si) photonics. However, other photonics technologies may be used. Similarly, only portions of the electro-optic devices are shown. For example, only the portions of the electrodes in the modulation region (e.g. where the electrode signal(s) are used to modulate the optical signal(s) are shown in at least some embodiments. In some embodiments, other optical devices may be included in addition to or in lieu of the optical modulator. The embodiments described and depicted herein indicate particular features of the electro-optic devices. However, the features may be combined in manners not explicitly depicted herein. Further, although primarily described in the context of particular electrode configurations (e.g. single-ended or differential (S, S*)), other configurations may be used. For example, electrode configurations may include but may not be limited to Ground-Signal-Signal-Ground and/or signals that do not use grounds. Although x-cut and z-cut are not explicitly indicated in most TFLC embodiments, at least some such embodiments may be usable with at least x-cut TFLC materials. Further, although in some embodiments a single waveguide, a single view of/set of electrodes, and/or a cross-section are shown, multiple waveguide (and/or multiple waveguide arms), multiple sets of electrodes and differing cross-sections may be used. For example, the cross-sections shown typically include extensions (portions of the electrode that extend from a main channel/transmission line/portion responsible for carrying the electrode signal). However, a single extension generally does not extend along the entire length of the electrode in the modulation region. For example, multiple extensions (e.g. T-shaped, L-shaped, or I-shaped) may be used along the modulation region.

Further, the capacitance, typically expressed as a capacitance per unit length, specifies capacitance of the contact electrode near TFLN waveguide in capacitance per unit length. For example, if the capacitance is 100 pF/m and the modulation region is 1 mm long, then total capacitance is 100 pF/m*0.001 m=100 fF. The capacitance may not include parasitic capacitance from e.g. the channel regions of the electrodes, which are not included in the simulations. This capacitance is from the portion of the electrodes near the TFLC waveguide (e.g. the portion of the extensions depicted herein in various cross-sections). Such electrodes may also be termed contact electrodes. The capacitance may also be considered to be the capacitance between the contact electrodes (e.g. between extensions) on opposite sides of the waveguide. Stated differently, the capacitance may be the capacitance (per unit length) across the gap between a pair of contact electrodes (e.g. a pair of extensions).

Various features of the photonics devices are described herein. One or more of these features may be combined in manners not explicitly described herein. For example, extensions that include transparent conductive material(s) (e.g., transparent conductive oxide) are shown in some embodiments. Transparent conductive materials may be used with other portions of the electrodes and/or extensions having different configurations. In another example, channel regions 422 may be included with electrodes 620, 720, 820, 920, and/or 1020. Similarly, a trench is shown in the waveguide slab in some embodiments, but may be present in other embodiments. Further, the electrodes and/or waveguides may be configured based on the cut (e.g., x-cut, y-cut, or z-cut) of the electro-optic materials used. The embodiments described herein may be configured for optical signals having wavelength of substantially 1310 nm. However, the configurations, and the attendant performance, may be extrapolated towards other wavelengths, including but not limited to O-band, C-band and L-band.

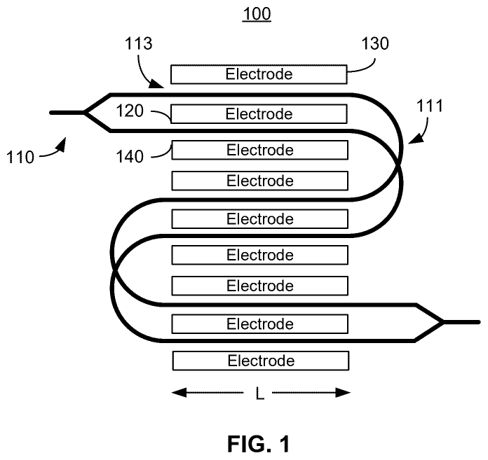

FIG. 1 is a block diagram of an embodiment of thin film lithium-containing (TFLC) electro-optic device 100 that may have improved efficiency. TFLC electro-optic device 100 may be an optical modulator. TFLC optical modulator 100 thus includes waveguide 110 having bend regions 111 (of which only one is labeled) and modulation region 113 (of which only one is labeled) as well as electrodes 120, 130 and 140. For clarity, only three electrodes 120, 130, and 140 are labeled. The electrodes (e.g. electrodes 120, 130, and 140) are shown in a Ground-Signal-Signal-Ground (GSSG) differential configuration. However, other configurations, for example other different differential configurations (e.g. GSGSG) and other signal ended configurations (e.g., GSG) may be used. The remaining electrodes shown may be part of the labeled electrodes (e.g. connected by portions of the electrodes that are further from waveguide 110 and are not shown) or separate electrodes. For clarity, only electrodes 120, 130, and 140 are discussed. For simplicity, only a portion of TFLC modulator 100 is shown. For example, only the portions of electrodes 120, 130, and 140 in modulation regions 113 are shown. Other components that may be present, such as photodetectors or portions of waveguide 110 configured for other purposes (e.g., polarization beam splitters or mode converters), are not shown. Although waveguide 110 includes a particular number of bend regions 111 and modulation regions 130, other configurations are possible. For example, bend regions 111 may be omitted for a shorter/smaller modulator 100. Modulation regions 113 are all shown as having length L. In some embodiments, different modulation regions 113 may have different lengths. Moreover waveguide crossings are shown in bend regions 111. Waveguide crossing(s) may be located elsewhere and/or may be omitted. In addition, although optical modulator 100 is configured as a Mach-Zehnder modulator, other configurations may be possible.

Waveguide 110 is a TFLC waveguide. In some embodiments, the TFLC material(s) used is/are or include(s) TFLN and/or TFLT. In some embodiments, the TFLC layer for waveguide 110 has a thickness of less than two micrometers, less than one micrometer, less than six hundred nanometers, less than five hundred nanometers, or less than four hundred nanometers, and at least ten nanometers prior to etches forming TFLC waveguide 110. Waveguide 110, as fabricated, may have thicknesses from not exceeding 800 nm to not exceeding 50 nm (e.g. 0-50 nm in thickness). In some regions, the waveguide may be removed (e.g., have zero thickness). In some embodiments, waveguide 110 includes both a ridge and a slab in at least modulation region 113. In some embodiments, waveguide 110 is a channel waveguide that does not have a thinner slab region in modulation regions 113. Also as used herein, an electrode carries a signal used in modulating the optical signal (or is ground). The electrode may include a solid electrode, an electrode including extensions (and thus a channel region), and/or other configuration(s). Electrodes 120 and 130 may be in a single-ended or differential mode.

Optical modulator 100 may be configured to have improved modulation efficiency without undue increases optical losses and/or impedance. This may be achieved through the configuration of waveguide 110 and electrode(s) 120, 130, and/or 140 in modulation regions 113. The cross-section of the optical modulator near the waveguide at least partially determines the modulation efficiency (e.g., as indicated by V-pi-L). The modulation efficiency of a device can be increased (i.e., V-pi-L decreased) by reducing the gap between the electrodes or introducing more metal layers. However, this usually results in higher optical propagation loss and larger capacitance, which leads to lower modulator impedance. These results are undesirable. For example, such a reduction in impedance may make impedance matching challenging for an optical modulator. Optical modulator 100 may increase the modulation efficiency (reduce V-pi-L) while maintaining acceptable optical propagation loss (e.g., less than 0.5 dB/cm) and capacitance (e.g., less than 100 pF/m per waveguide).

In some embodiments, optical modulator 10 may achieve an improved efficiency by configuring one or more of electrodes 120, 130 and/or 140 to have contour(s) or bends. For example, a portion of the electrode is proximate to the top surface of the slab or ridge of waveguide 110, while a second portion of the electrode is proximate to the side surface of the slab or ridge of waveguide 110. Thus, the electrodes (e.g. electrodes 120 and 130 or electrodes 120 and 140) have multiple separations. Stated differently, there are different gaps between different regions of pairs of electrodes. In some embodiments, the electrodes may also include top or bottom layers above and/or below waveguide 110. In some embodiments, these portions of the electrode(s) 120, 130, and/or 140 are formed by extensions. In some embodiments, these portions of electrode(s) 120, 130, and/or 140 are formed by the body of the electrode. Such a configuration of electrode(s) 120, 130, and/or 140 may reduce V-pi-L while maintaining optical losses and/or capacitances in the desired ranges. In some embodiments, electrode(s) 120, 130, and/or 140 and waveguide 110 may be configured such that optical modulator 100 has a V-pi-L of not more than 2 V-cm and a length of not more than 5 millimeters.

In some embodiments, electrode(s) 120, 130, and/or 140 are configured to provide a velocity mismatch through modulation region 113. An optical signal in the desired bandwidth range that travels through waveguide 110 may have an optical speed (e.g., the optical group velocity). An electrode signal (e.g., a radio frequency (RF) signal) may be considered to have an electrode signal speed. A difference in the optical speed in waveguide 110 and the electrode signal speed in electrode(s) 120, 130, and 140 is the velocity mismatch. The electrode signal speed in electrode(s) 120, 130, and/or 140 may be set using the geometry of electrodes 120, 130, and/or 140. For example, extensions (described below) may reduce the electrode signal speed.

In some embodiments, the velocity mismatch for optical modulator 100 may be at least one percent and not more than fifty percent. In some embodiments, the velocity mismatch is at least five percent. In some such embodiments, the modulation region has a length of not more than five millimeters. In some embodiments, the velocity mismatch between the RF electrode signal and the optical signal be greater than at least one of 50%, 30%, 20%, 10%, 5%, 3%, 2% or 1% of the optical group velocity. In some embodiments, the velocity mismatch between the RF electrode signal and the optical signal be not more than at least one of 50%, 30%, 20%, 10%, 5%, 3%, or 2% of the optical group velocity. In some such embodiments, the velocity mismatch between the RF electrode signal and optical signal may be set at greater than 10%, 7%, 4%, 2%, 1% and/or 0.5% divided by the length of the shortest straight sections (e.g., L) of electrode(s) 120, 130, and/or 140 in centimeters in each modulator. The optical speed may be higher than electrode signal speed. The electrode signal speed may be specified at 10 GHz, 20 GHz, 50 GHz, 70 GHz, 100 GHz or 130 GHz.

The optical signal speed in TFLC materials is generally higher than the electrode signal speed in electrodes 120, 130, and/or 140. Further, the electrode speed signal is proportional to the square root of the inductance multiplied by the capacitance of the electrodes 120, 130, and/or 140 (sqrt(LC)). A larger velocity mismatch generally results in increased losses. As a result, TFLC electro-optic modulators are generally configured to reduce the velocity mismatch. Changes in the capacitance and/or inductance for electrodes 120, 130, and/or 140 affect the impedance. Consequently, the inductance and capacitance of electrodes 120, 130, and/or 140 may be controlled to provide the desired velocity mismatch and the desired impedance matching. In addition to limits on the capacitance and inductance of the electrodes, velocity matching may be accomplished by using a path difference between the electrode signal (i.e. the electrode path) and the optical signal (e.g. the waveguide path) distal from the modulation regions. For example, the waveguide may have a meandering path distal from the modulation region to provide a longer path for the optical signal than for the electrode signal.

In some embodiments, the configuration of electrodes 102, 130, and/or 140 provides a larger velocity mismatch in the ranges described herein for each modulation region 113. However, by configuring the path length for the optical signal in bend regions 111, the total velocity mismatch for optical modulator 100 may be tailored. In some embodiments, modulation regions 113 are detuned to provide a larger velocity mismatch. Bend regions 111 are configured to reduce this mismatch (e.g. by allowing the optical signal to travel along a longer, meandering path). For example, a modulation region 113 may have a velocity mismatch of 50%. In bend regions 111, the optical signal may travel a larger distance than the electrode signal travels. Thus, the velocity mismatch for a modulation region 113 plus a bend region 115 may be less than ten percent. This detuning of the electrode signal and optical signal speeds may allow for increased modulator efficiency, without unduly increasing optical losses and modulator capacitance.

In some embodiments, electrodes 120, 130, and/or 140 may include or consist of transparent conductive material(s) (TCM(s)), such as transparent conductive oxides. For example, extensions, electrical connection between the channel and the extensions, portions of the electrode or the entire electrode may include or consist of the TCM(s). In these regions, the TCM portions of the electrodes may be transparent to (and not significantly interact with) the optical signal while still participating in propagation of an electrode signal. TCM(s) may allow for the optical losses to be mitigated.

In some embodiments, electrodes 120, 130, and/or 140 include structures such as apertures therein. Such structures may be used to tailor the inductance and capacitance of the electrodes. Apertures in electrodes 120, 140, and/or 140 may also reduce the capacitance per unit length and/or increase the inductance per unit length of optical modulator 100. In some such embodiments, an electrode pair (e.g., electrodes 120, and 130 or electrodes 120 and 140). For example, an electrode may have a capacitance of at least 10 pF/m and not more than 90 pF/m for a gap of the electrode pair and an impedance of at least 20 Ohms and not more than 80 Ohms.

Thus, using one or more of the techniques-contours in electrode(s) 120, 130, and/or 140), a velocity mismatch, and/or tailoring the capacitance of electrodes 120, 130, and/or 140, modulation efficiency may be improved while increases in optical propagation losses and/or capacitance may be mitigated.

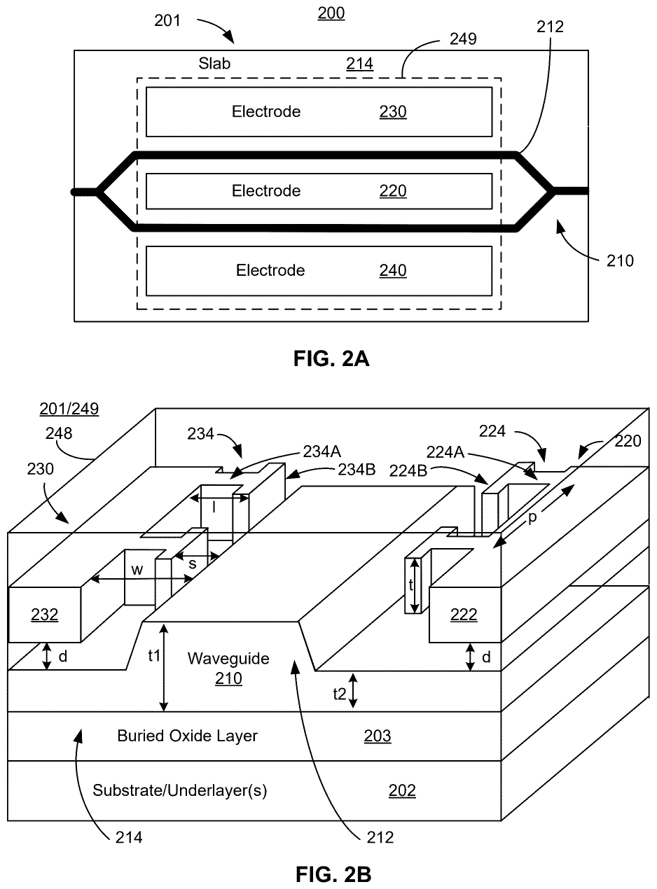

Although not expressly indicated in FIG. 1, optical modulators described herein, such as optical modulator 100, are TFLC optical modulators. Further, electrodes 120, 130, and/or 140 may include additional features. Some such TFLC PIC include TFLC optical modulators 105 among other structures. For example, FIGS. 2A-2B depict an embodiment of a portion of TFLC optical device 200 that may be used as part or all of a modulator used in TFLC photonics device 100. FIG. 2B is a perspective view of a portion of photonics device 200. FIGS. 2A-2B are not to scale. Only a portion of photonics device 200 is shown. Photonics device 200 may include other and/or additional structures that are not shown for simplicity. Further, although particular configurations are shown, other configurations are possible.

Photonics device 200 is on a substrate structure that includes substrate 202 and buried oxide (BOX) layer 203. In some embodiments, substrate 202 is a silicon substrate. Substrate 202 may also include other layers. In some embodiments, substrate 202 may be glass, quartz, silicon-on-insulator, and/or other low microwave loss dielectrics. Substrate 202 may be one hundred micrometers or more thick. BOX layer 203 may be a silicon dioxide layer. In some embodiments, BOX layer 203 may be at least three micrometers thick and not more than fifteen micrometers thick. In some embodiments, the substrate structure may be configured differently. Also shown is cladding 250, which may be formed of silicon dioxide. Substrate 202 (and/or other portions of photonics device 200) may be removed before final integration or other use of photonics device 200.

Photonics device 200 includes waveguide 210 and electrodes 220, 230, and 240. In some embodiments, photonics device 200 may be configured as or include a modulator (or portion thereof). Thus, photonics device 200 may be considered to include modulation region 249. Other regions, such as a bend region, may be present. Modulator 200 is shown as configured as a Mach-Zehnder modulator. Other configurations for phase and/or amplitude modulation are possible. For clarity, only the portion of electrodes 220, 230, and 240 proximate to waveguide 210 are shown. Stated differently, electrodes 220, 230, and 240 are shown in modulation region 260.

Waveguide 210 may be considered to include ridge 212 as well as slab 214. Ridge 212 has a height, t1, greater than the height, t2, of slab 214. Although shown as rectangles, ridge 212 and/or slab 214 have other shapes, such as trapezoids and/or other analogous shapes. In addition, slab 212 may terminate closer to ridge 212 than at least a portion of electrode(s) 220 and/or 230. Photonics device 200 includes electro-optic optic material(s), such as TFLC materials (e.g. TFLN and/or TFLT). More specifically, ridge 212 and slab 214 include electro-optic materials, such as TFLC materials. In some embodiments, the waveguide 210 consists of TFLC materials such as TFLN and/or TFLT. In the embodiment shown, ridge 212 and slab 214 are formed of the same material. In some embodiments, ridge 212 and slab 214 may include different materials. Waveguide 210, and more particularly ridge 212, may be used to propagate the optical signal. The optical mode may be well confined to ridge 212 and/or ridge 212 in combination with a portion of nearby slab 214. Slab 214 provides increased electro-optic modulation efficiency. In particular, slab 214 aids in directing the electric field generated by the signal(s) in electrodes 220, 230, and 240 to optical mode 213 in modulation region 260. Thus, a higher modulation for a given electric field may be obtained. As a result, V-pi (and V-pi-L) may be reduced.

In some embodiments, the TFLC layer from which TFLC waveguide 210 is formed has a thickness of less than two micrometers or less than one micrometer. Thus, TFLC waveguide 210 may have a thickness of less than two micrometers, less than one micrometer, less than six hundred nanometers, less than five hundred nanometers, or less than four hundred nanometers. The thickness of TFLC waveguide 210 may be at least fifty nanometers. In some embodiments, the TFLC layer has a thickness of at least two hundred and fifty nanometers. For example, TFLC waveguide 210 may be nominally three hundred nanometers or three hundred and fifty nanometers thick with, for example, a 10-15 nanometer variation. The thickness of TFLC waveguide 210 (e.g. t1, to the top of ridge 112) may be not more than three hundred nanometers, not more than three hundred and fifty nanometers, not more than four hundred nanometers, not more than five hundred nanometers, not more than six hundred nanometers, not more than seven hundred nanometers, not more than one micrometer, not more than 1.5 micrometer, and/or not more than two micrometers. In some embodiments, the thickness of TFLC waveguide 210 may be at least more than three hundred nanometers, at least three hundred and fifty nanometers, at least four hundred nanometers, at least five hundred nanometers, at least six hundred nanometers, at least seven hundred nanometers, at least one micrometer, or at least 1.5 micrometer.

The etches also form the sidewall angles for TFLC waveguide 110. The sidewall angles for ridge 112 and/or slab 114 may not exceed ninety degrees and are typically less than ninety degrees (e.g., not quite vertical). For example, the sidewall angles may be less than 85 degrees, less than 80 degrees, less than 75 degrees, and/or less than 70 degrees The sidewall angles may be desired to be steep. For example, the sidewall angles may be at least forty-five degrees, at least fifty-five degrees, or at least sixty degrees. The sidewalls may also have a lower surface roughness (e.g., less than ten nanometers), allowing for low optical losses in waveguides 210. TFLC waveguide 210 has a width (e.g., a smallest feature size) corresponding to the width of ridge 212. In some embodiments, the width of TFLC waveguide (i.e., TFLC optical structure) 210/ridge 212 is not more than one micrometer. This may be the smallest feature size for the TFLC waveguide 110. In some embodiments, the smallest feature size in the TFLC waveguide 110 is not more five hundred nanometers. In some such embodiments, the smallest feature size of TFLC waveguide 110 is not more than two micrometers or not more than one micrometer.

Electrodes 220, 230, and 240 may carry electrode signals used to modulate the optical signals (e.g. light) carried by waveguide 210 via electro-optic modulation. Electrode(s) 220 and/or 230 are configured to carry a traveling wave (e.g. a microwave or RF electrode signal) that modulates the optical signal carried by waveguide 210 via the electro-optic effect. For example, the electrode signals may provide electro-optic modulation up to frequencies of 100 GHz, 200 GHz, 500 GHz or higher. In some embodiments, modulator 210 may provide modulation from at or near DC to frequencies of 100 GHz, 200 GHz, 500 GHz, or more. The modulation may also have a wide window, for example an operation bandwidth of at least 20 GHz. Electrode signals carried by electrodes 220, 230, and 240 may be configured in a variety of manners. For example, electrode 230 may carry a microwave signal, while electrodes 220 and 240 are ground. Electrode 230 may carry a signal of a first polarity, while electrodes 220 and 240 carry signals of opposite polarity (i.e. in a differential configuration). Other configurations (including but not limited to another number of electrodes) are possible.

Electrodes 220, 230, and/or 240 may include extensions. Embodiments of analogous electrodes may be found in co-pending U.S. patent application Ser. No. 17/843,906, entitled ELECTRO-OPTIC DEVICES HAVING ENGINEERED ELECTRODES, which is a continuation of U.S. patent application Ser. No. 17/102,047 entitled ELECTRO-OPTIC DEVICES HAVING ENGINEERED ELECTRODES, filed Nov. 23, 2020, which claims priority to U.S. Provisional Patent Application No. 62/941,139 entitled THIN-FILM ELECTRO-OPTIC MODULATORS filed Nov. 27, 2019, U.S. Provisional Patent Application No. 63/033,666 entitled HIGH PERFORMANCE OPTICAL MODULATORS filed Jun. 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed Nov. 12, 2020, all of which are incorporated herein by reference for all purposes. In other embodiments, extensions may be omitted from some or all of electrodes 220, 230, and/or 240. Electrodes 220, 230, and 240 may carry differential electrical signals, a single electrical signal (e.g. a signal and ground), or other signal(s).

Electrode 230 includes a channel region 232 and extensions 234 (of which only one is labeled in FIG. 2B). Similarly, electrode 220 includes channel region 222 and extensions 224 (of which only one is labeled in FIG. 2B). In some embodiments, extensions 224 or 234 may be omitted from electrode 220 or electrode 230, respectively. Extensions 224 and 234 may be closer to ridge 212 than channel region 222 and 232, respectively, are. For example, the distance s from extensions 224 and 234 to waveguide ridge 212 is less than the distance w from channels 222 and 232 to waveguide ridge 212. Extensions 224 may be closer to electrode 230 (e.g. extensions 234 and/or channel 232) than channel 222 is. Similarly, extensions 234 may be closer to electrode 220 e.g. extensions 224 and/or channel 222) than channel 232 is.

Extensions 224 and 234 are in proximity to ridge 212. For example, extensions 224 and 234 are a vertical distance, d from slab 214 of TFLC waveguide 210. The vertical distance to TFLC waveguide 210 may depend upon the cladding 250 used. The distance d is highly customizable in some cases. For example, d may range from zero (or less if electrodes 220 and 230 contact or are embedded in slab portion 214) to greater than the height of ridge 212. In embodiments in which slab 214 terminates closer to ridge 212 than channel regions 222 and 232, d may be zero (same level as the top surface of slab 214), positive (further from substrate 202 than the top surface of slab 214), or negative (further from substrate 202 than the top surface of slab 214). However, d is generally still desired to be sufficiently small that electrodes 220 and 230 can apply the desired electric field to ridge 212. Extensions 224 and 234 are also a distance, s, from ridge 212. In some embodiments, s<0 (i.e., extensions 224 and/or 234 may extend over the top of ridge 212 or below waveguide 210). Extensions 224 and 234 are desired to be sufficiently close to TFLC waveguide 210 (e.g. close to ridge 212) that the desired electric field and index of refraction change can be achieved. However, extensions 224 and 234 are desired to be sufficiently far from TFLC waveguide 210 (e.g. from ridge 212) that their presence does not result in undue optical losses. Although shown next to ridge 212, extensions 224 and/or 234 may extend above and/or below ridge 212.

In the embodiment shown, extensions 224 have a connecting portion 224A and a retrograde portion 224B. Retrograde portion 224B is so named because a part of retrograde portion may be antiparallel to the direction of signal transmission through electrode 220. Similarly, extensions 234 have a connecting portion 234A and a retrograde portion 234B. Thus, extensions 224 and 234 have a “T”-shape. In some embodiments, other shapes are possible. For example, extensions 224 and/or 234 may have an “L”-shape, may omit the retrograde portion, may be rectangular, trapezoidal, parallelogram-shaped, may partially or fully wrap around a portion of ridge 212, and/or have another shape. Similarly, channel regions 222 and/or 232, which are shown as having a rectangular cross-section, may have another shape. Further, extensions 224 and/or 234 may be different sizes. Although all extensions 224 and 234 are shown as the same distance from ridge 212, some of extensions 224 and/or some of extensions 234 may be different distances from ridge 212. Channel regions 222 and/or 232 may also have a varying size.

Also indicated in FIG. 2B is thickness, t, of extensions 224 and 234. In the embodiment shown, channels 222 and 232 have the same thickness. In some embodiments, the thickness of extensions 224 and/or 234 may vary. For example, extensions 224 may be thinner (or thicker) than extensions 234. Further, different extensions 224 may have different thicknesses. Similarly, different extensions 234 may have different thicknesses. Extensions 224 and/or 234 may also have a different thickness than channels 222 and/or 232. For example, extensions 224 and/or 234 may be thinner (or thicker) than channels 222 and/or 232. Different portions of extensions 224 and/or 234 may also have different thicknesses. For example, retrograde portions 224B and/or 234B may be thinner (or thicker) than connecting portions 224A and/or 234B. Thus, TFLC PICs 200 and 100 may have a variety of configurations, components, and functions. Performance of TFLC PICs 200 and 100 may be superior to that of other, non-TFLC PICs.

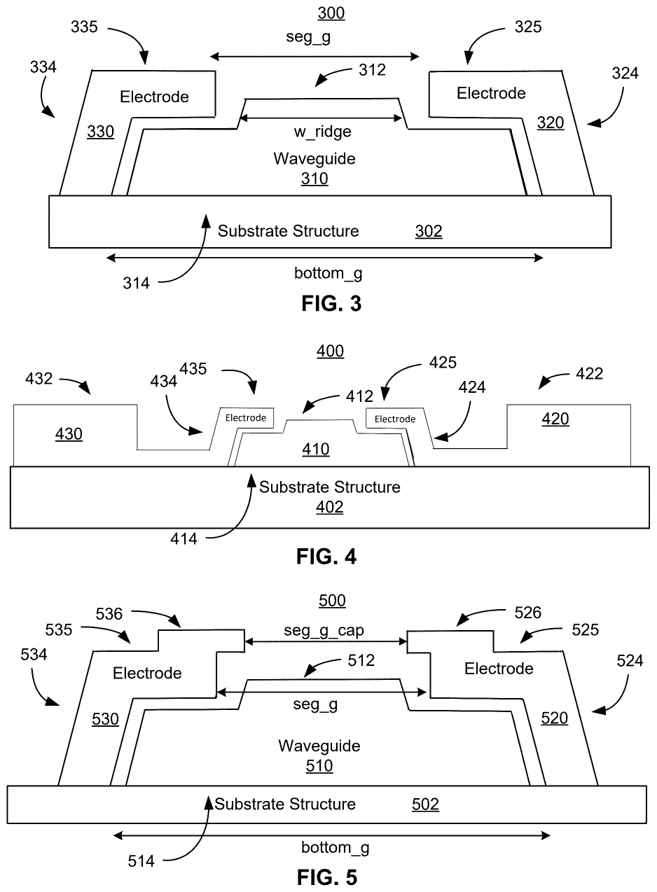

FIG. 3 depicts an embodiment of a portion of TFLC electro-optic device 300 that may have improved efficiency. The TFLC electro-optic device is or includes an optical modulator. FIG. 3 depicts a cross-sectional view of a modulation region of TFLC electro-optic device 300. For clarity, only a portion of TFLC electro-optic device 300 is shown. TFLC electro-optic device 300 is analogous to TFLC electro-optic devices 100 and/or 200. TFLC electro-optic device 300 includes TFLC waveguide 310 and electrodes 320 and 330 on substrate structure 302 that are analogous to waveguide 110 and/or 210, electrodes 120 and 130 and/or 220 and 230, and substrate structure 202. For example, substrate structure 302 may include a BOX layer and substrate and/or other underlying layers/structures. For example, CMOS and/or other devices may reside in substrate structure 302. Waveguide 310 includes ridge 312 and slab 314 analogous to ridge 212 and slab 214. In other embodiments, waveguide 310 may be a channel waveguide (e.g., analogous to waveguide 1810 depicted in FIG. 18).

Electrodes 320 and 330 may include or consist of conducting materials with low resistivity (e.g., <1 Ohm-cm, <10⁻³ ohm*cm, 10⁻⁴ ohm*cm). For example, electrodes 320 and 330 may include or consist of material(s) such as metals and transparent conductive materials (TCM). Examples of metals that may be used include but may not be limited to Cu, Al, Au, indium tin oxide (ITO), aluminum doped zinc oxide (AZO), and/or analogous materials. In some embodiments, the doping range of the TCM, such as AZO, may be limited. For example, AZO may be doped with greater than 0% aluminum and not more than 1% Al, not more than 2% Al, not more than 3% Al, not more than 4% Al, not more than 5% Al, not more than 6% Al, not more than 7% Al, not more than 8% Al, not more than 9% Al, or not more than 10% Al. other doping ranges are possible.

Electrode 320 includes side region 324 and top region 325 that are proximate to the sidewall and top of ridge 314, respectively. Top region 325 is separated from side region 324 by a contour (e.g., a bend) in electrode 320. Similarly, electrode 330 includes side region 334 and top region 335 that are separated by a contour and proximate to the sidewall and top of slab 314, respectively. In some embodiments, electrodes 320 and 330 are monolithic structures not including extensions. In some embodiments, electrodes 320 and/or 330 may include extensions (not shown). In some embodiments, some or all of top regions 325 may be formed by extensions.

Top regions 325 and 335 are separated by a top gap, seg_g that is greater than the width of ridge 312 (w_ridge) and less than the width of slab 314. The distance of top regions 325 and 335 from the underlying substrate (not shown) may be analogous to more traditional electrode. However top regions 325 and 335 are closer to ridge 312. Thus, the separation between top regions 325 and 335 has been reduced. In some embodiments, seg_g is less than three micrometers, less than four micrometers, or less than six micrometers (e.g. 1.5-6 micrometers). The width of ridge 312 may be at least one micrometer and not more than four micrometers.

Side regions 324 and 334 are separated by a larger gap corresponding to the width of slab 314. The width of slab 314 may be at least 2.5 micrometers and not more than eight micrometers. A small gap between ridge 314 and side regions 324 and 334 is shown. However, in some embodiments, side regions 324 and/or 334 of electrodes 320 and/or 330 may contact slab 314. This gap between ridge 314 and side regions 324 and 334 may be at least 0 nm and not more than 1000 nm. In some embodiments, this gap may be filled with materials with a relative dielectric constant equal or greater than 2, or greater than 3, or greater than 4. Such material(s) may include both conductive and non-conductive materials. The total thickness of waveguide 310 may be less than two micrometers, less than one micrometers, less than 700 nm, less than 500 nm or less than 400 nm. The bottom gap for side regions 324 and 334, bottom_g, is at least seg_g+0.5 micrometer, seg_g+1 micrometer or seg_g+2 micrometer. In some embodiments, the electrodes shown may be extensions coupled to a channel region (not shown).

As previously discussed, reducing the separation between the electrodes may improve the modulation efficiency (reduce V-pi-L), but may greatly increase optical losses and increase capacitance. Thus, a lower separation only reduces V-pi-L and increases capacitance (lowering impedance). Without more, reducing the top gap seg_g for top regions 325 and 335 as shown may increase modulation efficiency but result in greater optical losses. However, side regions 324 and 334 are also part of electrode 320 and 330. Thus, the electrodes have two separations: across the slab and across the ridge (seg_g). Stated differently, electrodes 320 and 330 have contours/corners (as opposed to be flat only, vertical only, or canted at a particular angle only.

Optical modulator 300 may share the benefits of TFLC optical modulators. For example, lower optical losses and a larger bandwidth might be achieved. The configuration of electrodes 320 and 330 may also improve modulation efficiency while reducing optical losses. Top regions 325 and 335 may be slower to ridge 312, allowing for a higher field at ridge 312 and an improved modulation efficiency. Thus, V-pi-L may be reduced. It has been determined that the addition of the side regions 324 and 334 may allow electrodes 320 and 330 to mitigate optical losses. Thus, performance of optical modulator 300 may be improved.

FIG. 4 depicts an embodiment of a portion of TFLC electro-optic device 400 that may have improved efficiency. The TFLC electro-optic device is or includes an optical modulator. FIG. 4 depicts a cross-sectional view of a modulation region of TFLC electro-optic device 400. For clarity, only a portion of TFLC electro-optic device 400 is shown. TFLC electro-optic device 400 is analogous to TFLC electro-optic devices 100, 200, and/or 300. TFLC electro-optic device 400 includes TFLC waveguide 410 and electrodes 420 and 430 on substrate structure 402 that are analogous to waveguide 110 and/or 310, electrodes 120 and 130 and/or 320 and 330, and substrate structure 202 and 302. Waveguide 410 includes ridge 412 and slab 414 analogous to ridge 312 and slab 314. In other embodiments, waveguide 410 may be a channel waveguide. Electrodes 420 and 430 include side regions 424 and 434 and top regions 425 and 435 that are analogous to side region 324 and top region 325.

Regions 434 and 435 and 424 and 425 shown are connected to channel region 432 and 422. Thus, regions 425 and 435 may be extensions in some embodiments. Regions 424 and 434 may be extensions or monolithic connections between extensions 425 and 435 and channel regions 433 and 432. The top gap and bottom gap between top regions 425 and 435 and side regions 424 and 435 are analogous to those discussed for optical modulator 300.

Thus, electrodes 420 and 430 may form a capacitively loaded structure. The extensions (e.g. regions 425 and 435) may improve the impedance matching with the electrical transmission line containing electrodes 420 and 430. For example, the impedance for electrodes 420 and 430 may reach 30 ohms or more differential or single-ended impedance, greater than 40 ohm differential or single-ended impedance, greater than 50 ohm differential or single-ended impedance, greater than 60 ohm differential or single-ended impedance, greater than 70 ohm differential or single-ended impedance, greater than 80 ohm differential or single-ended impedance, greater than 90 ohm differential or single-ended impedance, greater than 100 ohm differential or single-ended impedance, in a transmission line. In some embodiments, the impedance may not exceed 500 ohm differential or single-ended impedance. The transmission line may be coplanar transmission line or vertically stacked transmission line structure.

Optical modulator 400 may share the benefits of TFLC optical modulators 100, 200, and 300. For example, lower optical losses and a larger bandwidth might be achieved. The configuration of electrodes 420 and 430 may also improve modulation efficiency while mitigating optical losses. In addition, use of regions 425 and 435 and, in some embodiments, 424 and 434 as extensions may improve the impedance matching for the transmission lines containing electrodes 420 and 430. Thus, performance of optical modulator 300 may be improved.

FIG. 5 depicts an embodiment of a portion of TFLC electro-optic device 500 that may have improved efficiency. The TFLC electro-optic device is or includes an optical modulator. FIG. 5 depicts a cross-sectional view of a modulation region of TFLC electro-optic device 500. For clarity, only a portion of TFLC electro-optic device 500 is shown. TFLC electro-optic device 500 is analogous to TFLC electro-optic devices described herein, such as devices 300 and/or 400. TFLC electro-optic device 500 includes TFLC waveguide 510 and electrodes 520 and 530 on substrate structure 502 that are analogous to waveguide 310 and/or 410, electrodes 320 and 330 and/or 420 and 430, and substrate structure 302 and 402. Waveguide 510 includes ridge 512 and slab 514 analogous to ridge 312 and slab 314. In other embodiments, waveguide 510 may be a channel waveguide. Electrodes 520 and 530 include side regions 524 and 534 and top regions 525 and 535 that are analogous to side region 324 and top region 325.

Electrodes 520 and 530 also include cap regions 526 and 536. Thus, an additional metal layer has been added to the top of electrodes 520 and 530. Thus, electrodes 520 and 530 may have three separations: across slab 514 (bottom_g), across ridge 512 (seg_g), and above ridge 512 (seg_g_cap). As indicated in FIG. 5, seg_g_cap<seg_g<bottom_g.

Addition of the cap regions 526 and 536 may further improve modulation efficiency (reduce V-pi-L) without greatly increasing optical losses. In some embodiments, seg_g_cap may be less than 2 micrometers, or less than 3 micrometers, or less than 5 micrometers (e.g. 1-5.5 micrometers) The total thickness of ridge 512 and slab 514 may be less than 2 micrometers, less than 1 micrometer, less than 700 nm or less than 600 nm. The etch ratio of ridge 512 to the total thickness of the TFLC layer may be greater than 0.1 and less than 0.8. For example, the etch ratio may be at least 0.25 and not more than 0.7. The gap between electrodes 520 and 530 to the etched surface of slab 514 may be at least 50 nm and not more than 300 nm in some embodiments. The gap may be as small as 0 nm (contact) or as large as 500 nm or up to 1 micrometer in some embodiments. For example, the gap between slab 512 and electrodes 520 and 530 may be 0, less than or equal to 50 nm, less than or equal to 100 nm, less than or equal to 150 nm, less than or equal to 200 nm, less than or equal to 250 nm, less than or equal to 300 nm, less than or equal to 350 nm, less than or equal to 400 nm, less than or equal to 450 nm, or less than or equal to 500 nm. Electrodes 520 and 530 may be configured to have extensions (not shown) in the z-plane (perpendicular to the cross section). In some embodiments, electrodes 520 and 530 are extensions are coupled to channel regions (not shown). Stated differently, electrodes 520 and 530 may be analogous to electrodes 420 and 430.

Optical modulator 500 may share the benefits of TFLC optical modulators 100, 200, 300 and 400. For example, lower optical losses and a larger bandwidth might be achieved. The configuration of electrodes 520 and 530 may also improve modulation efficiency while mitigating optical losses. In addition, cap regions 526 and 536 may further enhance modulation efficiency. Thus, performance of optical modulator 500 may be improved.

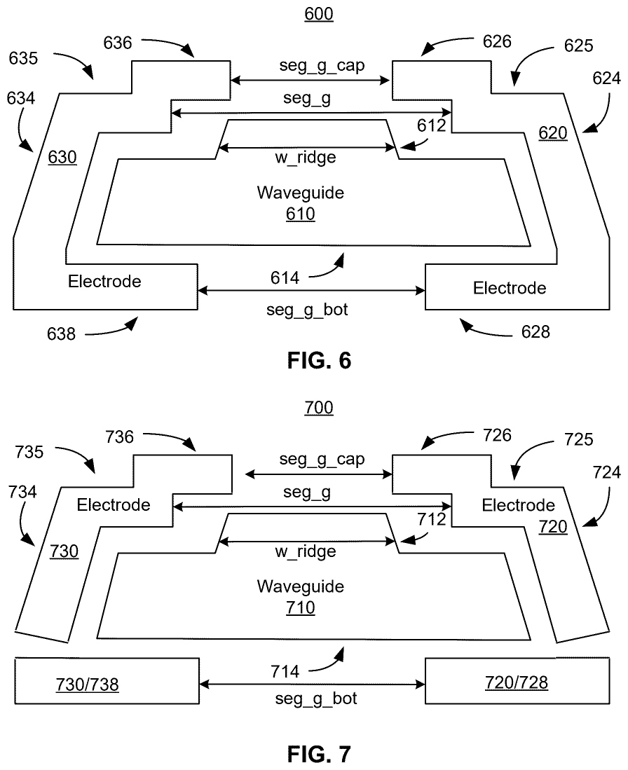

FIG. 6 depicts an embodiment of a portion of TFLC electro-optic device 600 that may have improved efficiency. The TFLC electro-optic device is or includes an optical modulator. FIG. 6 depicts a cross-sectional view of a modulation region of TFLC electro-optic device 600. For clarity, only a portion of TFLC electro-optic device 600 is shown. TFLC electro-optic device 600 is analogous to TFLC electro-optic devices described herein, such as devices 300 and/or 400. TFLC electro-optic device 600 includes TFLC waveguide 610 and electrodes 620 and 630 on substrate structure 602 that are analogous to waveguide 310 and/or 510, electrodes 320 and 330 and/or 520 and 530, and substrate structure 302 and 502. Waveguide 610 includes ridge 612 and slab 614 analogous to ridge 312 and slab 314. In other embodiments, waveguide 610 may be a channel waveguide. Electrodes 620 and 630 include side regions 624 and 634 and top regions 625 and 635 that are analogous to side region 324 and top region 325. Electrodes 620 and 630 also include cap regions 626 and 636 analogous to cap regions 526 and 536.

Electrodes 620 and 630 also include bottom regions 628 and 638. Bottom regions 628 and 638 are separated by a bottom gap, seg_g_bot, that is less than the width of slab 614. Traditional fabrication processes may make the placement of electrode bottom regions 628 and 638 extremely difficult. Instead, a hybrid bonding technology may be used to fabricate waveguides 610 and electrodes 620 and 630. The electrode gap seg_g_bot may be less than seg_g (i.e., the gap between top regions 625 and 635). Electrodes 620 and 630 may be extensions coupled to the channels (not shown) or unstructured (i.e. monolithic) electrodes without extensions.

Optical modulator 600 may share the benefits of TFLC optical modulators 100, 200, 300 and 400. For example, lower optical losses and a larger bandwidth might be achieved. The configuration of electrodes 620 and 630 may also improve modulation efficiency while mitigating optical losses. Thus, performance of optical modulator 600 may be improved.

FIG. 7 depicts an embodiment of a portion of TFLC electro-optic device 700 that may have improved efficiency. The TFLC electro-optic device is or includes an optical modulator. FIG. 7 depicts a cross-sectional view of a modulation region of TFLC electro-optic device 700. For clarity, only a portion of TFLC electro-optic device 700 is shown. TFLC electro-optic device 700 is analogous to TFLC electro-optic devices described herein, such as devices 300 and/or 600. TFLC electro-optic device 700 includes TFLC waveguide 710 and electrodes 720 and 730 on substrate structure 702 that are analogous to waveguide 310 and/or 610, electrodes 320 and 330 and/or 620 and 630, and substrate structure 302 and 602. Waveguide 710 includes ridge 712 and slab 714 analogous to ridge 312 and slab 314. In other embodiments, waveguide 710 may be a channel waveguide. Electrodes 720 and 730 include side regions 724 and 734 and top regions 725 and 735 that are analogous to side region 324 and top region 325. Electrodes 720 and 730 also include cap regions 726 and 736 analogous to cap regions 526 and 536.

Electrodes 720 and 730 also include bottom regions 728 and 738. Bottom regions 728 and 738 are separated by a bottom gap, seg_g_bot, that is less than the width of slab 714. In addition, bottom regions 728 and 738 are formed by a separate metal layer. Bottom regions 728 and 738 may be connected to the top electrode (i.e. regions 724, 725, and 726 and regions 734, 735, and 736) at certain places along the transmission line or channel (not shown). Thus, bottom regions 728 and 738 of electrodes 720 and 730 may not be directly coupled to/in physical contact with the upper portions of electrode 720 and 730. Electrodes 720 and 730 may be or include extensions. Cap regions 726 and 736 may be optional or may include additional layers. Electrodes 720 and 730 may have multiple levels, forming a staircase like structure. In some embodiments, electrodes 720 and 730 may be extensions coupled to a channel region (not shown) or unstructured, monolithic electrodes.

Optical modulator 700 may share the benefits of other TFLC optical modulators described herein, such as optical modulators 100, 200, 300 and 400. For example, lower optical losses and a larger bandwidth might be achieved. The configuration of electrodes 720 and 730 may also improve modulation efficiency while mitigating optical losses. Thus, performance of optical modulator 700 may be improved.

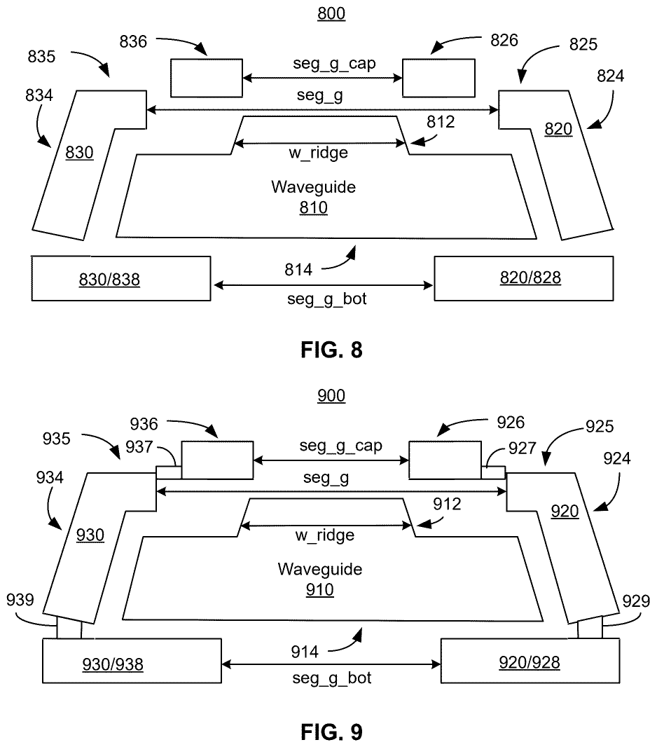

FIG. 8 depicts an embodiment of a portion of TFLC electro-optic device 800 that may have improved efficiency. The TFLC electro-optic device is or includes an optical modulator. FIG. 8 depicts a cross-sectional view of a modulation region of TFLC electro-optic device 800. For clarity, only a portion of TFLC electro-optic device 800 is shown. TFLC electro-optic device 800 is analogous to TFLC electro-optic devices described herein, such as devices 300 and/or 700. TFLC electro-optic device 800 includes TFLC waveguide 810 and electrodes 820 and 830 on substrate structure 802 that are analogous to waveguide 310 and/or 710, electrodes 320 and 330 and/or 720 and 730, and substrate structure 302 and 702. Waveguide 810 includes ridge 812 and slab 814 analogous to ridge 312 and slab 314. In other embodiments, waveguide 810 may be a channel waveguide. Electrodes 820 and 830 include side regions 824 and 834 and top regions 825 and 835 that are analogous to side region 324 and top region 325. Electrodes 820 and 830 also include cap regions 826 and 836 analogous to cap regions 526 and 536.

Electrodes 820 and 830 also include bottom regions 828 and 838 analogous to bottom regions 728 and 738. In addition to bottom regions 828 and 838 being separate, remaining elements or electrodes 820 and 830 are separately formed. Thus, cap regions 826 and 836 and top/side regions 825/824 and 835/834 are physically separate. Electrodes 820 and 830 may be formed by independent elements from a cross section perspective. This may facilitate the fabrication of the electrodes. Electrodes 820 and 830 may be or include extensions. Further regions 824/825, 826 and 828 and regions 834/835, 836, and 838 may be electrically connected elsewhere (e.g. to a driver or to a portion of a transmission line) to form electrodes 820 and 830. Regions 824/825, 826 and 828 and regions 834/835, 836, and 838 of electrodes 820 and 830 are connected in a way to facilitate electric field generation in between the electrodes. For example, each of regions 824/825, 826 and 828 and regions 834/835, 836, and 838 of the electrodes/extension 820 and 830 may be independently connected to a channel region. Thus, all regions 824/825, 826 and 828 and regions 834/835, 836, and 838 are (indirectly) electrically connected. In some embodiments, the gap between the bottom regions 828 and 838 and waveguide 810 may be less than 2 micrometers, less than 1.5 micrometer, less than 1.2 micrometer, less than micrometer, less than 500 nm, less than 200 nm or in contact with slab 314. The different electrodes regions 824/825, 826, 828, 834/835, 836, and 838 may be different conducting materials. Although shown as connected, regions 824 and 825 and regions 834 and 835 may also be separate. In some embodiments, electrodes 820 and 830 may be extensions coupled to a channel region (not shown) or unstructured electrodes.

Optical modulator 800 may share the benefits of other TFLC optical modulators described herein, such as optical modulators 100, 200, 300 and 400. For example, lower optical losses and a larger bandwidth might be achieved. The configuration of electrodes 820 and 830 may also improve modulation efficiency while mitigating optical losses. Thus, performance of optical modulator 800 may be improved.

FIG. 9 depicts an embodiment of a portion of TFLC electro-optic device 900 that may have improved efficiency. The TFLC electro-optic device is or includes an optical modulator. FIG. 9 depicts a cross-sectional view of a modulation region of TFLC electro-optic device 900. For clarity, only a portion of TFLC electro-optic device 900 is shown. TFLC electro-optic device 900 is analogous to TFLC electro-optic devices described herein, such as devices 300 and/or 800. TFLC electro-optic device 900 includes TFLC waveguide 910 and electrodes 920 and 930 on substrate structure 902 that are analogous to waveguide 310 and/or 810, electrodes 320 and 330 and/or 820 and 830, and substrate structure 302 and 802. Waveguide 910 includes ridge 912 and slab 914 analogous to ridge 312 and slab 314. In other embodiments, waveguide 910 may be a channel waveguide. Electrodes 920 and 930 include side regions 924 and 934 and top regions 925 and 935 that are analogous to side region 824 and top region 825. Electrodes 920 and 930 also include cap regions 926 and 936 analogous to cap regions 826 and 836.

Electrodes 920 and 930 are analogous to electrodes 820 and 830. Thus, regions 924/925, 926 and 928 and regions 934/935, 936, and 938 of electrodes 920 and 930 are independently formed but connected in a way to facilitate electric field generation in between the electrodes. For example, regions 924 and 928 and connected by via 929. Similarly, regions 934 and 938 and connected by via 939. Regions 925 and 926 and connected by via 927. Similarly, regions 935 and 936 and connected by via 937. Other connection techniques may be used in other embodiments.

Optical modulator 900 may share the benefits of other TFLC optical modulators described herein, such as optical modulators 100, 200, 300 and 400. For example, lower optical losses and a larger bandwidth might be achieved. The configuration of electrodes 920 and 930 may also improve modulation efficiency while mitigating optical losses. Thus, performance of optical modulator 900 may be improved.

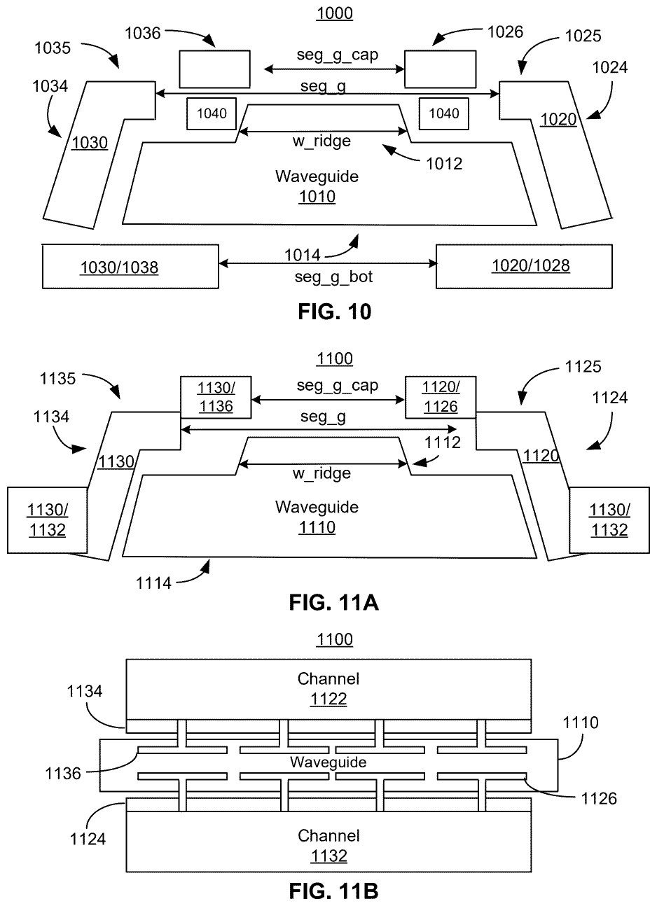

FIG. 10 depicts an embodiment of a portion of TFLC electro-optic device 1000 that may have improved efficiency. The TFLC electro-optic device is or includes an optical modulator. FIG. 10 depicts a cross-sectional view of a modulation region of TFLC electro-optic device 1000. For clarity, only a portion of TFLC electro-optic device 1000 is shown. TFLC electro-optic device 1000 is analogous to TFLC electro-optic devices described herein, such as devices 300 and/or 800. TFLC electro-optic device 1000 includes TFLC waveguide 1010 and electrodes 1020 and 1030 on substrate structure 1002 that are analogous to waveguide 310 and/or 810, electrodes 320 and 330 and/or 820 and 830, and substrate structure 302 and 802. Waveguide 1010 includes ridge 1012 and slab 1014 analogous to ridge 312 and slab 314. In other embodiments, waveguide 1010 may be a channel waveguide. Electrodes 1020 and 1030 include side regions 1024 and 1034 and top regions 1025 and 1035 that are analogous to side region 824 and top region 825. Electrodes 1020 and 1030 also include cap regions 1026 and 1036 analogous to cap regions 826 and 836.

Electrodes 1020 and 1030 are analogous to electrodes 820 and 830. Thus, regions 1024/925, 1026 and 1028 and regions 1034/935, 1036, and 1038 of electrodes 1020 and 1030 are independently formed but connected in a way to facilitate electric field generation in between the electrodes. Also shown is connecting material 1040 that has a dielectric constant greater than the cladding material. In some embodiments, the connecting material has a dielectric constant that is also less than the dielectric constant for TFLC of waveguide 310. For example, the high dielectric constant material 1040 may be or include a transparent conductive material (TCM). The connecting material may be present for configurations that use independent electrode regions, such as 800, 900, and/or 1000. The connecting material 1040 may be or include Al₂O₃, MgO, AZO, ITO, TiO₂, HfO, and/or analogous materials. In some embodiments, regions 1024/925, 1026 and 1028 and regions 1034/935, 1036, and 1038 of electrodes 1020 and 1030 may be directly coupled, coupled through vias, coupled at the channel region (not shown), or in another manner. In some embodiments, the electrodes 1020 and/or 1030 may be or include extensions coupled to a channel region (not shown) or unstructured, monolithic electrodes not having extensions.

Optical modulator 1000 may share the benefits of other TFLC optical modulators described herein, such as optical modulators 100, 200, 300 and 400. For example, lower optical losses and a larger bandwidth might be achieved. The configuration of electrodes 1020 and 1030 may also improve modulation efficiency while mitigating optical losses. Thus, performance of optical modulator 1000 may be improved.

FIGS. 11A-11B depict an embodiment of a portion of TFLC electro-optic device 1100 that may have improved efficiency. FIG. 11A depicts a cross-sectional view, while FIG. 11B depicts a plan view. For clarity, only a portion of TFLC electro-optic device 1100 is shown. TFLC electro-optic device 1100 is analogous to TFLC electro-optic devices described herein, such as device 300. TFLC electro-optic device 1100 includes TFLC waveguide 1110 and electrodes 1120 and 1130 on substrate structure 1102 that are analogous to waveguide 310, electrodes 320 and 330, and substrate structure 302. Waveguide 1110 includes ridge 1112 and slab 1114 analogous to ridge 312 and slab 314. In other embodiments, waveguide 1110 may be a channel waveguide. Electrodes 1120 and 1130 include side regions 1124 and 1134 and top regions 1125 and 1135 that are analogous to side regions 324 and 334 and top regions 325 and 335. Electrodes 1120 and 1130 also include channel regions 1122 and 1132 that are analogous to channel regions 222 and 232.

Electrodes 1120 and 1130 also include cap regions 1126 and 1136 that are analogous to, e.g., cap regions 726 and 736. However, cap regions 1126 and 1136 are configured as T-shaped extensions. However, regions 1124/1125 and 1134/1135 are monolithic/unstructured. Electrodes 1120 and 1130 thus contain a combination of extensions (capacitive loaded) electrodes 1126 and 1136 and non-structured continuous electrodes. For example, the diagram shows T-shaped extensions 1126 and 1136 and regular electrode bottom connection electrodes 1124/1125 and 1134/1135 which couple extensions 1126 and 1136 to channel electrodes 1122 and 1132. In practice, any electrodes described herein could include extensions (be “segmented”), not include extensions (“non-segmented”) or combinations of both. Although not shown in FIGS. 11A and 11B, bottom regions such as regions 1028 and 1038, may or may not be present. If bottom regions are present, the bottom regions may also be channel electrodes, carrying a transmission line signal (e.g., the electrode signal). In addition, driver electrodes (not shown) may be connected to a separate set of transmission line electrodes, delivering high speed modulation signals to modulator 1100. Although depicted as unstructured, in some embodiments, the regions 1124/1125 and 1134/1135 that serve as connection electrodes may be segmented/formed as extensions. The T-shaped extensions 1126 and 1136 may be made from the same material as or a different material from other portion(s) of the electrodes. Further, extensions 1126 and 1136 may have another shape.

Optical modulator 1100 may share the benefits of other TFLC optical modulators described herein, such as optical modulators 100, 200, 300 and 400. For example, lower optical losses and a larger bandwidth might be achieved. The configuration of electrodes 1120 and 1130 may also improve modulation efficiency while mitigating optical losses. Thus, performance of optical modulator 1100 may be improved.

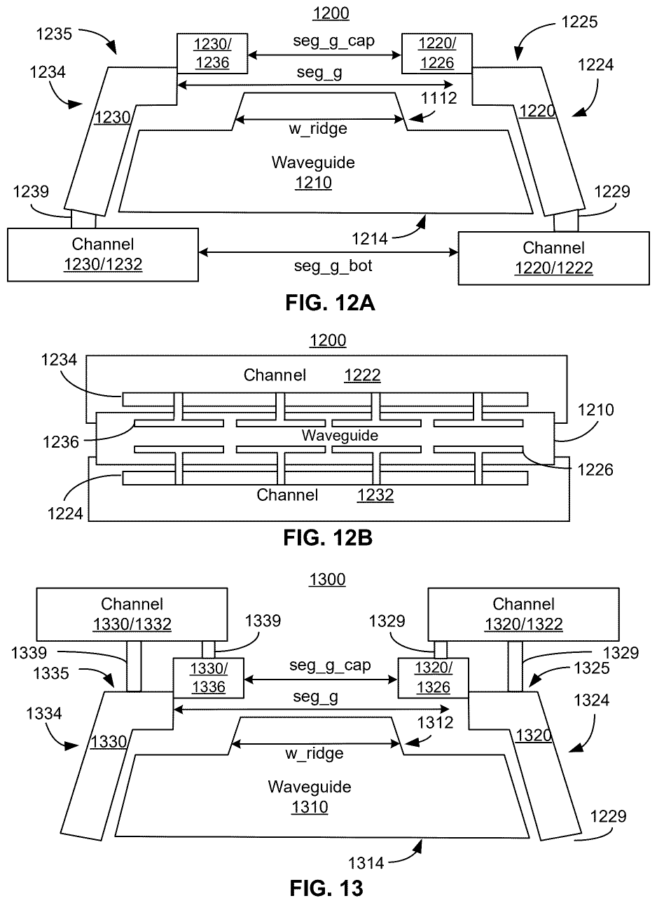

FIGS. 12A-12B depict an embodiment of a portion of TFLC electro-optic device 1200 that may have improved efficiency. FIG. 12A depicts a cross-sectional view, while FIG. 12B depicts a plan view. For clarity, only a portion of TFLC electro-optic device 1200 is shown. TFLC electro-optic device 1200 is analogous to TFLC electro-optic devices described herein, such as device 300. TFLC electro-optic device 1200 includes TFLC waveguide 1210 and electrodes 1220 and 1230 on substrate structure 1202 that are analogous to waveguide 310, electrodes 320 and 330, and substrate structure 302. Waveguide 1210 includes ridge 1212 and slab 1214 analogous to ridge 312 and slab 314. In other embodiments, waveguide 1210 may be a channel waveguide. Electrodes 1220 and 1230 include side regions 1224 and 1234 and top regions 1225 and 1235 that are analogous to side regions 324 and 334 and top regions 325 and 335. Electrodes 1220 and 1230 also include channel regions 1222 and 1232 that are analogous to channel regions 222 and 232.

Electrodes 1220 and 1230 are analogous to electrodes 1120 and 1130. Thus, electrodes 1220 and 1230 also include cap regions 1226 and 1236 that are analogous to, e.g., cap regions 1126 and 1136. Thus, cap regions 1226 and 1236 are configured as T-shaped extensions. Connection regions 1224/1234 and 1234/1235 are unstructured, monolithic electrode regions analogous to regions 1124/1125 and 1134/1135. Electrodes 1220 and 1230 also include channel regions 1222 and 1232 analogous to channel regions 1122 and 1132. However, the transmission line, or channel electrodes 1222 and 1232 are bottom electrodes (i.e. below the connection electrode regions 1224/1225 and 1234/1235). In the embodiment shown, the channel regions 1122 and 1132 are below waveguide 1210 as well as below the connection electrode regions 1224/1225 and 1234/1235 and extensions 1226 and 1236. In the embodiment shown, extensions 1126 and 1136 are T-shaped. Other shapes are possible. The upper electrodes 1224/1225/1226 and 1234/1235/1236 are connected to the transmission line/channel regions 1222/1232 through vias 1229 and 1239 (or segments connections). Although the connection electrodes 1224/1225 and 1234/1235 are shown as being unstructured, in some embodiments, the connection electrodes may include or be extensions. T-shaped extensions 1226 and 1236 may be made from the same material as or a different material from other portion(s) of the electrodes 1220 and 1230. Further, the extensions may have another shape.

Optical modulator 1200 may share the benefits of other TFLC optical modulators described herein, such as optical modulators 100, 200, 300 and 400. For example, lower optical losses and a larger bandwidth might be achieved. The configuration of electrodes 1220 and 1230 may also improve modulation efficiency while mitigating optical losses. Thus, performance of optical modulator 1200 may be improved.

FIG. 13 depicts an embodiment of a portion of TFLC electro-optic device 1300 that may have improved efficiency. FIG. 13 depicts a cross-sectional view of device 1300. For clarity, only a portion of TFLC electro-optic device 1300 is shown. TFLC electro-optic device 1300 is analogous to TFLC electro-optic devices described herein, such as device 300. TFLC electro-optic device 1300 includes TFLC waveguide 1310 and electrodes 1320 and 1330 on substrate structure 1302 that are analogous to waveguide 310, electrodes 320 and 330, and substrate structure 302. Waveguide 1310 includes ridge 1312 and slab 1314 analogous to ridge 312 and slab 314. In other embodiments, waveguide 1310 may be a channel waveguide. Electrodes 1320 and 1330 include side regions 1324 and 1334 and top regions 1325 and 1335 that are analogous to side regions 324 and 334 and top regions 325 and 335. Electrodes 1320 and 1330 also include cap regions 1326 and 1336 and channel regions 1322 and 1332 that are analogous to cap regions 726 or 1226 and 736 or 1236 channel regions 222 and 232.

Electrodes 1320 and 1330 are analogous to electrodes 1120 and 1130. Thus, electrodes 1320 and 1330 also include cap regions 1326 and 1336 that are analogous to, e.g., cap regions 1126 and 1136. Thus, cap regions 1326 and 1336 are configured as T-shaped extensions. Connection regions 1324/1234 and 1334/1235 are unstructured, monolithic electrode regions analogous to regions 1124/1125 and 1134/1135. Electrodes 1320 and 1330 also include channel regions 1322 and 1332 analogous to channel regions 1122 and 1132. However, the transmission line, or channel electrodes 1322 and 1332 are top electrodes (i.e. above the connection electrode regions 1324/1225 and 1334/1235). In the embodiment shown, the channel regions 1122 and 1132 are above waveguide 1310 as well as above connection electrode regions 1324/1225 and 1334/1235 and extensions 1326 and 1336. Channel regions 1322 and 1332 are connected to regions 1324/1225 and 1334/1235 and to regions 1326 and 1336 by conductive vias 1339, In some embodiments, the connection electrode regions 1324/1225 and 1334/1235 may be electrically and physically connected directly to extensions 1226 and 1236. In such embodiments, the via 1339 for extensions 1326 and 1336 or the via 1339 for the connection electrode regions 1324/1225 and 1334/1235 may be omitted. The connection electrode regions 1324/1225 and 1334/1235 may be unstructured or formed as extensions (e.g. with each extension coupled to the channel). Extensions 326 and 1336 may be made from the same material as or a different material from other portion(s) of the electrodes. Further, extensions 1326 and/or 1336 may be T-shaped or have another shape.

Optical modulator 1300 may share the benefits of other TFLC optical modulators described herein, such as optical modulators 100, 200, 300 and 400. For example, lower optical losses and a larger bandwidth might be achieved. The configuration of electrodes 1320 and 1330 may also improve modulation efficiency while mitigating optical losses. Thus, performance of optical modulator 1300 may be improved.

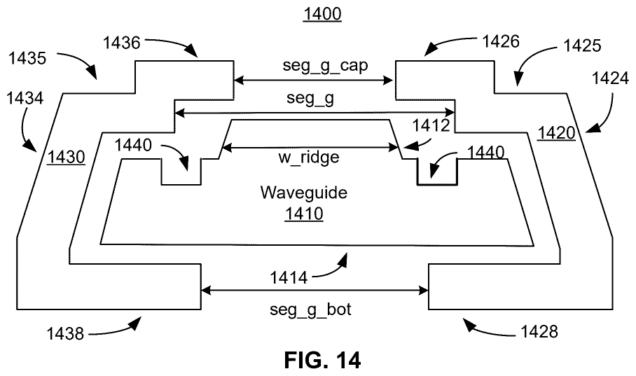

FIG. 14 depicts an embodiment of a portion of TFLC electro-optic device 1400 that may have improved efficiency. FIG. 14 depicts a cross-sectional view of device 1400. For clarity, only a portion of TFLC electro-optic device 1400 is shown. TFLC electro-optic device 1400 is analogous to TFLC electro-optic devices described herein, such as device 300. TFLC electro-optic device 1400 includes TFLC waveguide 1410 and electrodes 1420 and 1430 on substrate structure 1402 that are analogous to waveguide 310, electrodes 320 and 330, and substrate structure 302. Waveguide 1410 includes ridge 1412 and slab 1414 analogous to ridge 312 and slab 314. In other embodiments, waveguide 1410 may be a channel waveguide. Electrodes 1420 and 1430 include side regions 1424 and 1434 and top regions 1425 and 1435 that are analogous to side regions 324 and 334 and top regions 325 and 335. Electrodes 1420 and 1430 also include cap regions 1426 and 1436 and channel regions 1422 and 1432 that are analogous to cap regions 726 or 1226 and 736 or 1236 channel regions 222 and 232.

Electrodes 1420 and 1430 are analogous to electrodes 620 and 630. Thus, electrodes 1420 and 1430 include side regions 1424 and 1434, top regions 1425 and 1435, cap regions 1426 and 1436, and bottom regions 1428 and 1438 that are analogous to side regions 624 and 634, top regions 625 and 635, cap regions 626 and 636, and bottom regions 628 and 638. In addition, depressions (or trenches) 1440 may be formed in slab 1414 between ridge 1410 and the edge of slab 1414. In some embodiments, the depression depth is at least 1/10, not more than ½0 or not more than ¾ of the thickness of slab 1414. This may improve confinement of the optical mode to closer to ridge 1412. Modulation efficiency may be improved (V-pi-L reduced), optical losses may remain low, and capacitance may increase somewhat. The optical mode may be tightly confined in slab 1414 to be closer to ridge 1412 (i.e. closer to the center of the drawing) and further away from the side metal/electrode regions 1424 and 1434. Thus, losses may be improved. In some embodiments, the distance from the base of ridge 1412 to depression 1440 may be less than 0.1 micrometer, less than 0.3 micrometer, less than 0.5 micrometer (e.g. 0.05 micrometer to 0.7 micrometer). The depth of depression 1440 may be about half of the thickness of slab 1414 in some embodiments. Electrodes 1420 and 1430 may be formed as or including extensions or may be unstructured, monolithic electrodes. Such extensions may be T-shaped or have another shape. In some embodiments, depression may mitigate stress in slab 1410.

Optical modulator 1400 may share the benefits of other TFLC optical modulators described herein, such as optical modulators 100, 200, 300 and 400. For example, lower optical losses and a larger bandwidth might be achieved. The configuration of electrodes 1420 and 1430 may also improve modulation efficiency while mitigating optical losses. In addition, depressions 1410 may further mitigate optical losses. Thus, performance of optical modulator 1400 may be improved.

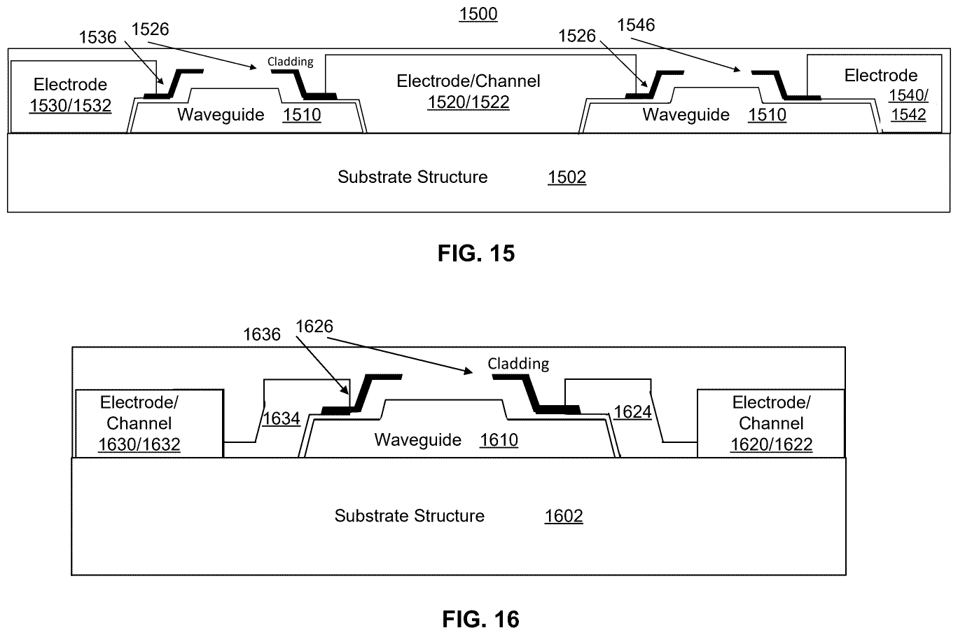

FIG. 15 depicts an embodiment of a portion of TFLC electro-optic device 1500 that may have improved efficiency. FIG. 15 depicts a cross-sectional view of device 1500. For clarity, only a portion of TFLC electro-optic device 1500 is shown. TFLC electro-optic device 1500 is analogous to TFLC electro-optic devices described herein, such as device 100, 200, and/or 300. TFLC electro-optic device 1500 includes TFLC waveguide 1510 and electrodes 1520, 1530, and 1540 on substrate structure 1502 that are analogous to waveguide 110, 210 and 310, electrodes 120, 130, 140, 220, 230, 320 and 330, and substrate structures 202 and 302. Waveguides 1510 each includes ridge (not labeled) and slab (not labeled) analogous to ridge 212 and 312 and slab 214 and 314. In other embodiments, waveguide(s) 1510 may be channel waveguide(s). Electrodes 1520 and 1530 include channel regions 1522 and 1532 analogous to channel regions 222 and 232.

Electrodes 1520 and 1530 also include extensions 1526 and 1536 analogous to extensions 224 and 234, 11226 and 1136, and/or 1226 and 1236. However, extensions 1526 and 1536 include or consist of TCM. For example, extensions 1526 and/or 1536 may include or consist of indium tin oxide (ITO), aluminum doped zinc oxide (AZO), and/or analogous material(s). Thus, extensions 1526 and 1536 may be transparent to light, but still conductive. In addition, extensions 1526 and 1536 include contours (bends/corners) such that extensions 1526 and 1536 are at least partially conformal with waveguides 1510. Stated differently, extensions 1526 and 1536 reside at multiple heights (distances from the underlying substrate structure 1502). In other embodiments, extensions 1526 and 1536 may be configured differently.

A small gap may exist between a portion of extensions 1526 and 1536 and waveguide 1510. The gap may be filled with oxides, such as SiO₂, Al₂O₃, MgO and/or other analogous materials. In some embodiments, the small gap is at least 1 nm, at least 5 nm, or at least 10 nm. In some embodiments, the small. gap is not more than 50 nm, not more than 30 nm, or not more than 20 nm thick. In some embodiments, the small gap may be used as an etch stop for processing the TCM, such as AZO, of extensions 1526 and 1536. For example, the selectivity between silicon dioxide and the oxides or other materials in the small gap and, e.g., AZO for extensions 1526 and 1536 may be 30-35:1, Similarly, the selectivity between aluminum oxide and AZO may be on the order of 2.5-3: Further, the ALD of the oxide (e.g. silicon oxide) for the small gap and the AZO may be performed in the same chamber. Thus, low optical losses in the waveguide may be maintained and processing facilitated. TCM is, however, expected to increase the capacitance. For larger regions of electrodes 1520 and 1530 being formed of TCM, this increase in capacitance may be significant. In addition, TCM extensions 1526 and 1536 may have substantial resistance if connected directly to channel electrode 1522 and 1532. An unstructured, monolithic structure or extensions may connect to TCM extensions 1526 and 1536. Such an embodiment is indicated in FIG. 16. Channel regions 1522 and 1532 include a higher conductivity material. Thus, improved (higher) conductivity and lower capacitance (higher impedance) may be maintained.

Optical modulator 1500 may share the benefits of other TFLC optical modulators described herein, such as optical modulators 100, 200, 300 and 400. For example, lower optical losses and a larger bandwidth might be achieved. The configuration of electrodes 1520 and 1530 may also improve modulation efficiency while mitigating optical losses. In addition, extensions 1526 and 1536 including TCM may reduce optical propagation losses for modulator 1500. Consequently, the modulation efficiency of electrodes 1520 and 1530 may be improved and losses mitigated. Thus, performance of optical modulator 1500 may be improved.

FIG. 16 depicts an embodiment of a portion of TFLC electro-optic device 1600 that may have improved efficiency. FIG. 16 depicts a cross-sectional view of device 1600. For clarity, only a portion of TFLC electro-optic device 1600 is shown. TFLC electro-optic device 1600 is analogous to TFLC electro-optic devices described herein, such as device 100, 200, and/or 300. TFLC electro-optic device 1600 includes TFLC waveguide 1610 and electrodes 1620, 1630, and 1640 on substrate structure 1602 that are analogous to waveguide 110, 210 and 310, electrodes 120, 130, 140, 220, 230, 320 and 330, and substrate structures 202 and 302. Waveguides 1610 each includes ridge (not labeled) and slab (not labeled) analogous to ridge 212 and 312 and slab 214 and 314. In other embodiments, waveguide(s) 1610 may be channel waveguide(s). Electrodes 1620 and 1630 include channel regions 1622 and 1632 analogous to channel regions 222 and 232.

Electrodes 1620 and 1630 also include extensions 1626 and 1636 analogous to extensions 1526 and 1536. Thus, extensions 1626 and 1636 include or consist of TCM. Extensions 1626 and 1636 include contours (bends/corners) such that extensions 1626 and 1636 are at least partially conformal with waveguides 1610. In other embodiments, extensions 1626 and 1636 may be configured differently. Electrodes 1620 and 1634 also include connecting portion 1624 and 1634 that are analogous to side regions 324 and 334 and top regions 325 and 335.

Optical modulator 1600 may share the benefits of other TFLC optical modulators described herein, such as optical modulators 100, 200, 300 and 400. For example, lower optical losses and a larger bandwidth might be achieved. The configuration of electrodes 1620 and 1630 may also improve modulation efficiency while mitigating optical losses. Use of TCM in extensions 1626 and 1636 may further mitigate losses. Thus, performance of optical modulator 1600 may be improved.

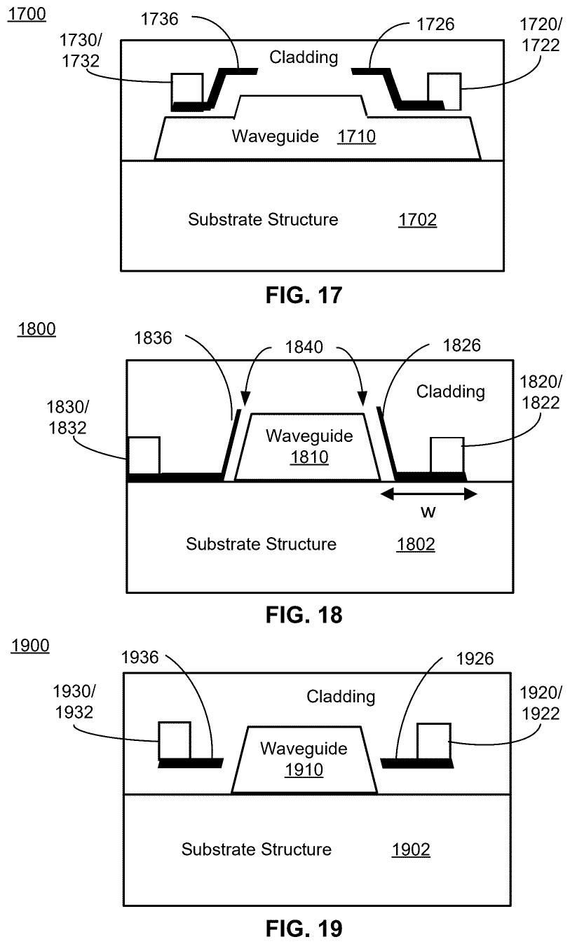

FIG. 17 depicts an embodiment of a portion of TFLC electro-optic device 1700 that may have improved efficiency. FIG. 17 depicts a cross-sectional view of device 1700. For clarity, only a portion of TFLC electro-optic device 1700 is shown. TFLC electro-optic device 1700 is analogous to TFLC electro-optic devices described herein, such as devices 1500 and/or 1600. TFLC electro-optic device 1700 includes TFLC waveguide 1710 and electrodes 1720, 1730, and 1740 on substrate structure 1702 that are analogous to waveguide 1510 and 1610, electrodes 1520, 1305, 1620 and 1630, and substrate structures 1502 and 1602. Waveguides 1710 each includes ridge (not labeled) and slab (not labeled) analogous to ridge 212 and 312 and slab 214 and 314. In other embodiments, waveguide(s) 1710 may be channel waveguide(s). Electrodes 1720 and 1730 include channel regions 1722 and 1732 analogous to channel regions 1522, 1532, 1622 and 1632. Electrodes 1720 and 1730 also include extensions 1726 and 1736 analogous to extensions 1526 and 1536. Thus, extensions 1726 and 1736 include or consist of TCM. Extensions 1726 and 1736 include contours (bends/corners) such that extensions 1726 and 1736 are at least partially conformal with waveguides 1710. In other embodiments, extensions 1726 and 1736 may be configured differently.

Optical modulator 1700 may share the benefits of other TFLC optical modulators described herein, such as optical modulators 100, 200, 300 and 400. For example, lower optical losses and a larger bandwidth might be achieved. The configuration of electrodes 1720 and 1730 may also improve modulation efficiency while mitigating optical losses. Use of TCM in extensions 1726 and 1736 may further mitigate losses. Thus, performance of optical modulator 1700 may be improved.

FIG. 18 depicts an embodiment of a portion of TFLC electro-optic device 1800 that may have improved efficiency. FIG. 18 depicts a cross-sectional view of device 1800. For clarity, only a portion of TFLC electro-optic device 1800 is shown. TFLC electro-optic device 1800 is analogous to TFLC electro-optic devices described herein, such as devices 1500 and/or 1600. TFLC electro-optic device 1800 includes TFLC waveguide 1810 and electrodes 1820, 1830, and 1840 on substrate structure 1802 that are analogous to waveguide 1510 and 1610, electrodes 1520, 1305, 1620 and 1630, and substrate structures 1502 and 1602. Waveguide 1810 is a channel waveguide. In other embodiments, waveguide 1810 may be configured differently. Electrodes 1820 and 1830 include channel regions 1822 and 1832 analogous to channel regions 1522, 1532, 1622 and 1632. Electrodes 1820 and 1830 also include extensions 1826 and 1836 analogous to extensions 1526 and 1536. Thus, extensions 1826 and 1836 include or consist of TCM. Extensions 1826 and 1836 include contours (bends/corners) such that extensions 1826 and 1836 are at least partially conformal with waveguides 1810. In other embodiments, extensions 1826 and 1836 may be configured differently.

Optical modulator 1800 may share the benefits of other TFLC optical modulators described herein, such as optical modulators 100, 200, 300 and 400. For example, lower optical losses and a larger bandwidth might be achieved. The configuration of electrodes 1820 and 1830 may also improve modulation efficiency while mitigating optical losses. Use of TCM in extensions 1826 and 1836 may further mitigate optical losses. Thus, performance of optical modulator 1800 may be improved.

FIG. 19 depicts an embodiment of a portion of TFLC electro-optic device 1900 that may have improved efficiency. FIG. 19 depicts a cross-sectional view of device 1900. For clarity, only a portion of TFLC electro-optic device 1900 is shown. TFLC electro-optic device 1900 is analogous to TFLC electro-optic devices described herein, such as devices 1500 and/or 1600. TFLC electro-optic device 1900 includes TFLC waveguide 1910 and electrodes 1920, 1930, and 1940 on substrate structure 1902 that are analogous to waveguide 1510 and 1610, electrodes 1520, 1305, 1620 and 1630, and substrate structures 1502 and 1602. Waveguide 1910 is a channel waveguide. In other embodiments, waveguide 1910 may be configured differently. Electrodes 1920 and 1930 include channel regions 1922 and 1932 analogous to channel regions 1522, 1532, 1622 and 1632. Electrodes 1920 and 1930 also include extensions 1926 and 1936 analogous to extensions 1526 and 1536. Thus, extensions 1926 and 1936 include or consist of TCM. Extensions 1926 and 1936 are substantially flat. Thus, extensions 1926 and 1936 may not include contours or bends. In other embodiments, extensions 1926 and 1936 may be configured differently.

Optical modulator 1900 may share the benefits of other TFLC optical modulators described herein, such as optical modulators 100, 200, 300 and 400. For example, lower optical losses and a larger bandwidth might be achieved. The configuration of electrodes 1920 and 1930 may also improve modulation efficiency while mitigating optical losses. Use of TCM in extensions 1926 and 1936 may further mitigate losses. Thus, performance of optical modulator 1900 may be improved.

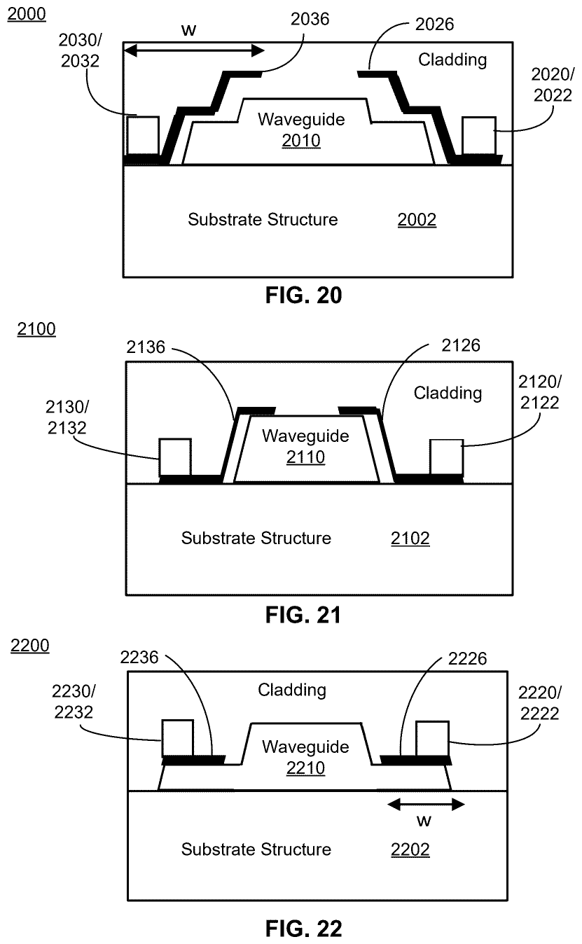

FIG. 20 depicts an embodiment of a portion of TFLC electro-optic device 2000 that may have improved efficiency. FIG. 20 depicts a cross-sectional view of device 2000. For clarity, only a portion of TFLC electro-optic device 2000 is shown. TFLC electro-optic device 2000 is analogous to TFLC electro-optic devices described herein, such as devices 1500 and/or 1600. TFLC electro-optic device 2000 includes TFLC waveguide 2010 and electrodes 2020, 2030, and 2040 on substrate structure 2002 that are analogous to waveguide 1510 and 1610, electrodes 1520, 1305, 1620 and 1630, and substrate structures 1502 and 1602. Waveguide 2010 includes a ridge (not labeled) and a slab (not labeled) analogous to ridge 212 and slab 214. In other embodiments, waveguide 2010 may be configured differently. Electrodes 2020 and 2030 include channel regions 2022 and 2032 analogous to channel regions 1522, 1532, 1622 and 1632. Electrodes 2020 and 2030 also include extensions 2026 and 2036 analogous to extensions 1526 and 1536. Thus, extensions 2026 and 2036 include or consist of TCM. Extensions 2026 and 2036 not only include multiple contours but extend from the base of waveguide 2010. In other embodiments, extensions 2026 and 2036 may be configured differently.

Optical modulator 2000 may share the benefits of other TFLC optical modulators described herein, such as optical modulators 100, 200, 300 and 400. For example, lower optical losses and a larger bandwidth might be achieved. The configuration of electrodes 2020 and 2030 may also improve modulation efficiency while mitigating optical losses. Use of TCM in extensions 2026 and 2036 may further mitigate losses. Thus, performance of optical modulator 2000 may be improved.

FIG. 21 depicts an embodiment of a portion of TFLC electro-optic device 2100 that may have improved efficiency. FIG. 21 depicts a cross-sectional view of device 2100. For clarity, only a portion of TFLC electro-optic device 2100 is shown. TFLC electro-optic device 2100 is analogous to TFLC electro-optic devices described herein, such as devices 1500 and/or 1600. TFLC electro-optic device 2100 includes TFLC waveguide 2110 and electrodes 2120, 2130, and 2140 on substrate structure 2102 that are analogous to waveguide 1510 and 1610, electrodes 1520, 1305, 1620 and 1630, and substrate structures 1502 and 1602. Waveguide 2110 is a channel waveguide. In other embodiments, waveguide 2110 may be configured differently. Electrodes 2120 and 2130 include channel regions 2122 and 2132 analogous to channel regions 1522, 1532, 1622 and 1632. Electrodes 2120 and 2130 also include extensions 2126 and 2136 analogous to extensions 1526 and 1536. Thus, extensions 2126 and 2136 include or consist of TCM. Extensions 2126 and 2136 not only include multiple contours, but extend from the base of waveguide 2110. In other embodiments, extensions 2126 and 2136 may be configured differently.

Optical modulator 2100 may share the benefits of other TFLC optical modulators described herein, such as optical modulators 100, 210, 300 and 400. For example, lower optical losses and a larger bandwidth might be achieved. The configuration of electrodes 2120 and 2130 may also improve modulation efficiency while mitigating optical losses. Use of TCM in extensions 2126 and 2136 may further mitigate losses. Thus, performance of optical modulator 2100 may be improved.

FIG. 22 depicts an embodiment of a portion of TFLC electro-optic device 2200 that may have improved efficiency. FIG. 22 depicts a cross-sectional view of device 2200. For clarity, only a portion of TFLC electro-optic device 2200 is shown. TFLC electro-optic device 2200 is analogous to TFLC electro-optic devices described herein, such as devices 1500 and/or 1600. TFLC electro-optic device 2200 includes TFLC waveguide 2210 and electrodes 2220, 2230, and 2240 on substrate structure 2202 that are analogous to waveguide 1510 and 1610, electrodes 1520, 1305, 1620 and 1630, and substrate structures 1502 and 1602. Waveguide 2210 includes a ridge (not labeled) and a slab (not labeled) analogous to ridge 222 and slab 224. In other embodiments, waveguide 2210 may be configured differently. Electrodes 2220 and 2230 include channel regions 2222 and 2232 analogous to channel regions 1522, 1532, 1622 and 1632. Electrodes 2220 and 2230 also include extensions 2226 and 2236 analogous to extensions 1526 and 1536. Thus, extensions 2226 and 2236 include or consist of TCM. Extensions 2226 and 2236 are substantially flat. In other embodiments, extensions 2226 and 2236 may be configured differently.

Optical modulator 2200 may share the benefits of other TFLC optical modulators described herein, such as optical modulators 100, 220, 300 and 400. For example, lower optical losses and a larger bandwidth might be achieved. The configuration of electrodes 2220 and 2230 may also improve modulation efficiency while mitigating optical losses. Use of TCM in extensions 2226 and 2236 may further mitigate losses. Thus, performance of optical modulator 2200 may be improved.

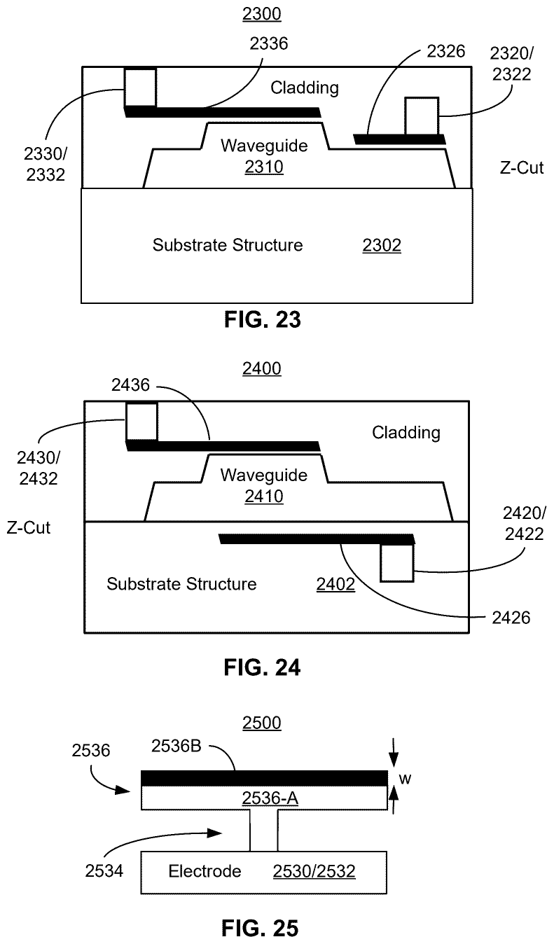

FIG. 23 depicts an embodiment of a portion of TFLC electro-optic device 2300 that may have improved efficiency. FIG. 23 depicts a cross-sectional view of device 2300. For clarity, only a portion of TFLC electro-optic device 2300 is shown. TFLC electro-optic device 2300 is analogous to TFLC electro-optic devices described herein, such as devices 1500 and/or 1600. TFLC electro-optic device 2300 includes TFLC waveguide 2310 and electrodes 2320, 2330, and 2340 on substrate structure 2302 that are analogous to waveguide 1510 and 1610, electrodes 1520, 1305, 1620 and 1630, and substrate structures 1502 and 1602. Waveguide 2310 includes a ridge (not labeled) and a slab (not labeled) analogous to ridge 232 and slab 234. In other embodiments, waveguide 2310 may be configured differently. Electrodes 2320 and 2330 include channel regions 2322 and 2332 analogous to channel regions 1522, 1532, 1622 and 1632. Electrodes 2320 and 2330 also include extensions 2326 and 2336 analogous to extensions 1526 and 1536. Thus, extensions 2326 and 2336 include or consist of TCM. Extensions 2326 and 2336 are substantially flat. In addition, one extension 2336 extends over the top of the ridge as well as a portion of the slab. Extension 2326 extends only over a portion of the slab. In other embodiments, extensions 2326 and 2336 may be configured differently. Further, electro-optic device 2300 is a z-cut device.

Optical modulator 2300 may share the benefits of other TFLC optical modulators described herein, such as optical modulators 100, 230, 300 and 400. For example, lower optical losses and a larger bandwidth might be achieved. The configuration of electrodes 2320 and 2330 may also improve modulation efficiency while mitigating optical losses. Use of TCM in extensions 2326 and 2336 may further mitigate losses. The benefits of the designs described herein may be extended to z-cut modulators. Thus, performance of optical modulator 2300 may be improved.

FIG. 24 depicts an embodiment of a portion of TFLC electro-optic device 2400 that may have improved efficiency. FIG. 24 depicts a cross-sectional view of device 2400. For clarity, only a portion of TFLC electro-optic device 2400 is shown. TFLC electro-optic device 2400 is analogous to TFLC electro-optic devices described herein, such as devices 1500 and/or 1600. TFLC electro-optic device 2400 includes TFLC waveguide 2410 and electrodes 2420, 2430, and 2440 on substrate structure 2402 that are analogous to waveguide 1510 and 1610, electrodes 1520, 1305, 1620 and 1630, and substrate structures 1502 and 1602. Waveguide 2410 includes a ridge (not labeled) and a slab (not labeled) analogous to ridge 242 and slab 244. In other embodiments, waveguide 2410 may be configured differently. Electrodes 2420 and 2430 include channel regions 2422 and 2432 analogous to channel regions 1522, 1532, 1622 and 1632. Electrodes 2420 and 2430 also include extensions 2426 and 2436 analogous to extensions 1526 and 1536. Thus, extensions 2426 and 2436 include or consist of TCM. Extensions 2426 and 2436 are substantially flat. In addition, one extension 2436 extends over the top of waveguide 2410, while extension 2426 extends under a portion of waveguide 2310. In other embodiments, extensions 2426 and 2436 may be configured differently. Further, electro-optic device 2400 is a z-cut device.

Optical modulator 2400 may share the benefits of other TFLC optical modulators described herein, such as optical modulators 100, 240, 300 and 400. For example, lower optical losses and a larger bandwidth might be achieved. The configuration of electrodes 2420 and 2430 may also improve modulation efficiency while mitigating optical losses. Use of TCM in extensions 2426 and 2436 may further mitigate losses. The benefits of the designs described herein may be extended to z-cut modulators. Thus, performance of optical modulator 2400 may be improved.

FIG. 25 depicts an embodiment of a portion of TFLC electro-optic device 2500 that may have improved efficiency. FIG. 25 depicts a plan view of device 2500. For clarity, only a portion of TFLC electro-optic device 2500 is shown. TFLC electro-optic device 2500 is analogous to TFLC electro-optic devices described herein, such as devices 1500 and/or 1600. TFLC electro-optic device 2500 includes electrode 2530. waveguides and other structures are not shown. The portion of electrode 2530 shown includes channel 2532, connecting portion 2534, and extensions 2536. Extensions include TCM portion 2536B and metal portion 2536A.

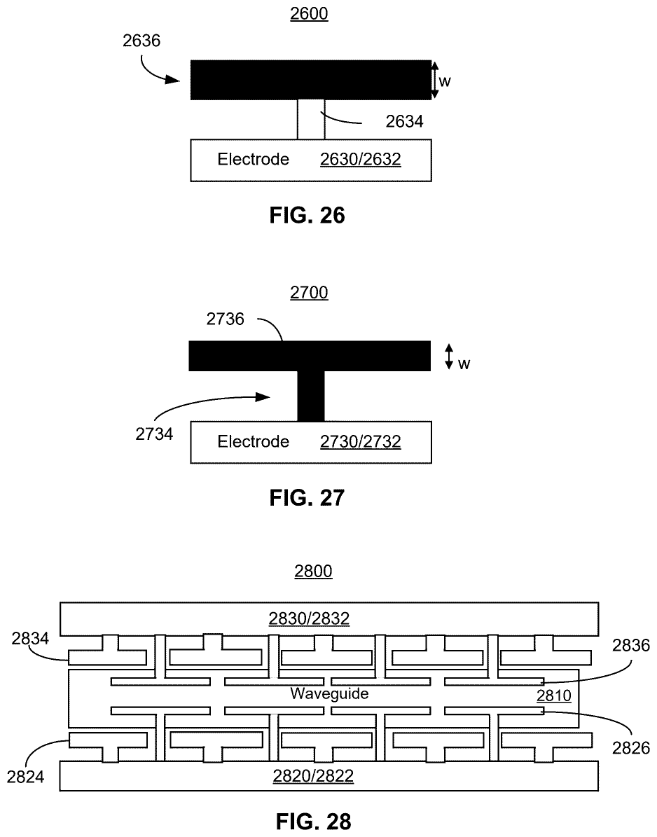

FIG. 26 depicts an embodiment of a portion of TFLC electro-optic device 2600 that may have improved efficiency. FIG. 26 depicts a plan view of device 2600. For clarity, only a portion of TFLC electro-optic device 2600 is shown. TFLC electro-optic device 2600 is analogous to TFLC electro-optic devices described herein, such as devices 1500 and/or 1600. TFLC electro-optic device 2600 includes electrode 2630. waveguides and other structures are not shown. The portion of electrode 2630 shown includes channel 2632, connecting portion 2634, and extensions 2636. Extensions 2626 consist of TCM.

FIG. 27 depicts an embodiment of a portion of TFLC electro-optic device 2700 that may have improved efficiency. FIG. 27 depicts a plan view of device 2700. For clarity, only a portion of TFLC electro-optic device 2700 is shown. TFLC electro-optic device 2700 is analogous to TFLC electro-optic devices described herein, such as devices 1500 and/or 1600. TFLC electro-optic device 2700 includes electrode 2730. waveguides and other structures are not shown. The portion of electrode 2730 shown includes channel 2732, connecting portion 2734, and extensions 2736. Extensions 2736 and connecting portion 2734 are formed of TCM.

Thus, some or all of extensions 2536, 2636, and 2735 and connecting regions 2534, 2634 and 2734 may include or consist of TCM. Connecting regions 2734 are formed of TCM, increasing the resistance of electrode 2730 significantly. In addition, horizontal width (e.g. w, the top of the T for T-shaped extensions) formed of TCM 2536B, 2636, and 2736 may be controlled to limit the capacitance increase. For example, w may be less than 10 micrometers, less than 5 micrometers, less than 3 micrometers, less than 2 micrometers, less than 1 micrometer, or less than 0.5 micrometer for extensions 2636 and 2736 that are formed of TCM. The TCM thickness may be at least 10 nm thick, less than 50 nm thick, less than 100 nm thick, less than 200 nm thick, less than 300 nm thick or less than 500 nm thick. This design methodology and geometry principles apply to z-cut as well as to x-cut optical modulators.

Optical modulators 2500, 2600, and 2700 may share the benefits of other TFLC optical modulators described herein, such as optical modulators 100, 250, 300 and 400. For example, lower optical losses and a larger bandwidth might be achieved. The configuration of electrodes 2530, 2630, and 2730 may also improve modulation efficiency while mitigating optical losses. Use of TCM in extensions 2536B, 2636, and 2736 may further mitigate losses. Thus, performance of optical modulator 2500 may be improved.

FIG. 28 depicts an embodiment of a portion of TFLC electro-optic device 2800 that may have improved efficiency. FIG. 28 depicts a plan view of electro-optic device 2800. For clarity, only a portion of TFLC electro-optic device 2800 is shown. TFLC electro-optic device 2800 is analogous to TFLC electro-optic devices described herein, such as device 300. TFLC electro-optic device 2800 includes TFLC waveguide 2810 and electrodes 2820 and 2830 that are analogous to waveguide 310 and electrodes 320 and 330. Waveguide 2810 may include a ridge (not labeled) and a slab (not labeled) analogous to ridge 312 and slab 314. In other embodiments, waveguide 2810 may be a channel waveguide. Electrodes 2820 and 2830 include side extensions 2824 and 2834 and top extensions 2826 and 2836 that are analogous to side regions 324 and 334 and extensions described herein. Electrodes 2820 and 2830 also include channel regions 2822 and 2832 that are analogous to channel regions 222 and 232.

Electrodes 2820 and 2830 also include cap regions 2826 and 2836 that are analogous to, e.g., cap regions 726 and 736. However, cap regions 2826 and 2836 are configured as T-shaped extensions and regions 2824/1125 and 2834/1135 are monolithic/unstructured. Electrodes 2820 and 2830 thus contain a combination of extensions (capacitive loaded) electrodes 2826 and 2836 and non-structured continuous electrodes. For example, optical modulator 2800 includes T-shaped extensions 2826 and 2836 and regular electrode bottom connection electrodes 2824/1125 and 2834/1135 which couple extensions 2826 and 2836 to channel electrodes 2822 and 2832. In practice, any electrodes described herein could include extensions (be “segmented”), not include extensions (“non-segmented”) or combinations of both. Although not shown in FIGS. 28A and 28B, bottom regions such as regions 1028 and 1038, may or may not be present. If bottom regions are present, the bottom regions may also be channel electrodes, carrying a transmission line signal (e.g., the electrode signal). In addition, driver electrodes (not shown) may be connected to a separate set of transmission line electrodes, delivering high speed modulation signals to modulator 2800. Although depicted as T-shaped extensions, in some embodiments, the regions 2824 and 2834 that serve as connection electrodes may be segmented/formed as extensions. The T-shaped extensions 2826 and 2836 may be made from the same material as or a different material from other portion(s) of the electrodes. Further, extensions 2826 and 2836 may have another shape. Through the use of extensions 2826 and 2836, as well as T-shaped regions 2824 and 2834, the impedance of optical modulator may be better maintained even for electrodes 2820 and 2830 that are closer together than in a conventional modulator.

Low V-pi-L structures (i.e. structures having a reduced separation between electrodes without other structures) dramatically increases the capacitance per unit length along the modulators. For example, the capacitance may be greater than 60 pF/m, greater than 70 pF/m, greater than 80 pF/m or greater than 90 pF/m for such conventional modulators. The impedance of the electrodes is proportional to sqrt(L/C), while electrode signal velocity is proportional to sqrt(LC), where L is inductance and C is capacitance. Drivers (not shown and which may be off-chip) for the electrodes 2820 and 2830 may have impedances in the range of 30-60 ohms for a single-ended driver or 40-120 ohms differential impedance drivers. Thus, the increase in capacitance of a traditional low V-pi-L structure may make impedance matching to commonly available drivers challenging if velocity matching conditions (e.g. velocity mismatch of less than 1%, less than 2%, or less than 5%) are maintained. Consequently, conventional modulators tune the velocities (i.e. have velocity matching) and simply allow for a higher V-pi-L.

One way to address this problem is to use structured electrodes (e.g. capacitance loaded electrodes) that include extensions (also known as segments). The extensions and other portions of the structures\may maintain (or only slightly change) the capacitance per unit length while increasing the inductance per unit length. This may keep the transmission line (i.e., electrode) impedance sufficiently high for impedance matching. To do this, one, multiple, or all electrodes may contain extensions. Thus, electrodes described herein and including extensions may be used in such embodiments.

In addition, the transmission line electrodes, such as channel regions 2822 and 2832, may be narrow to achieve the optimized impedance. The signal electrodes in both single ended and differential drive configuration may have a width that is less than 25 micrometers, less than 20 micrometers, less than 15 micrometers, less than 10 micrometers or less than 5 micrometers wide. Thus, some embodiments may have a low V-pi-L (which is desirable) and a sufficiently high impedance in the ranges described herein. In some embodiments, these characteristics may be achieved by detuning the electrode signal and optical speeds.

To increase the impedance (which may be reduced by more closely spaced electrodes and the attendant increase in capacitance), the electrode (e.g. channels 2822 and/or 2832) may have small, sub-micron dimensions. For example, the minimum thickness of the electrode channels 2822 and/or 2832 may be less than or about 1 micrometer, less than or about 500 nm, less than or about 300 nm, less than or about 200 nm, less than or about 100 nm or less or about 50 nm. Thus, various techniques, including but not limited to the use of extensions and other structures incorporated into electrodes, the change from impedance matching due to a smaller separation between electrodes.

To further compensate for the impedance drop due to the more efficient (low electrode separation) V-pi-L structure, electrodes 2820 and 2830 may be configured to have an intentional velocity mismatch between the transmission line electrical signal and optical signal. Stated differently, the electrode signal speed and the optical speed may be intentionally detuned. The velocity mismatch between the RF electrode signal and optical signal may be set at greater than at least one of 50%, 30%, 20%, 10%, 5%, 3%, 2% or 1% of the optical group velocity. Further, the velocity mismatch between the RF and optical signal may be set at greater than 10%, 7%, 4%, 2%, 1% and 0.5% divided by the length of the shortest straight sections of electrode in centimeters in each modulator. The optical speed may be higher than electrode signal speed. The electrode signal speed may be specified at 10 GHz, 20 GHz, 50 GHz, 70 GHz, 100 GHz or 130 GHz. This detuning of the velocity matching conditions may be accomplished by, for example, designing electrodes 2820 and/or 2830 to have a lower electrode signal speed.

The length of the modulator (or modulation region) may be selected based upon the mismatch in the electrode signal speed and the optical signal speed. In some embodiments, the length of the modulation region (L, in FIG. 1) is less than 10 mm, less than 7 mm, less than 5 mm, less than 4 mm, less than 3 mm, less than 2 mm or 1 mm. The modulator V-pi (differential Vpp and single ended Vp) maybe less than 9V, less than 7V, less than 5V, less than 3V, less than 2V, or less than 1V. Each modulator 2800 may occupy a total area (including all modulation region(s) and any bend(s)) of approximately 3 mm² or less, 2.5 mm² or less, 2 mm² or less, 1 mm² or less, or 0.5 mm² or less. The modulator may contain at least 1 U-bend or 1 S-bend. For example, the modulator may include a bend analogous to bend regions 113 of modulator 100. The U-bend and S-bend may be designed to have a different effective RF and Optical path length. Thus, a phase difference introduced by the velocity mismatch in the modulation region may be partially or completely compensated for in a corresponding bend region. Consequently, bend regions may be desirable in a velocity detuned modulator such as modulator 2800.

V-pi-L for RF (e.g. microwave) signals (also termed RF V-pi-L) may correspond to specific impedances or impedance ranges. Thus, in some embodiments, RF V-pi-L may be identified for specific impedances or impedance ranges. For example, for RF V-pi-L at a 5 GHz electrode signal frequency to be less than 2.5 V-cm, less than 2 V-cm, not more than 1.5 V-cm, or not more than nominally 1 V-cm, and where the input voltage is specified as the peak-to-peak voltage measured on a transmission line, the transmission line impedance may be a single-ended impedance that is nominally 50 ohms (e.g. 40-60 ohms). Similarly, in some embodiments, RF V-pi-L for a differential input voltage at 5 GHz to be less than 2.5 V-cm, less than 2 V-cm, not more than 1.5 V-cm and not more than nominally 1 V-cm, and where the input voltage is specified as the differential peak-to-peak voltage that would be measured on a transmission line, the impedance may be an 85 ohm (e.g. 80-90 Ohms) differential impedance. Other values of RF V-pi-L may be achieved for other frequencies and impedance ranges. Thus, a low V-pi-L may be achieved for microwave signals at higher impedances. Such characteristics may be particularly achievable for velocity detuned modulators that may be short (e.g. in the length ranges above, such as nominally 10 mm or less in length at the modulation region).

Optical modulator 2800 may share the benefits of other TFLC optical modulators described herein, such as optical modulators 100, 200, 300 and 400. For example, lower optical losses and a larger bandwidth might be achieved. The configuration of electrodes 2820 and 2830 may also improve modulation efficiency while mitigating optical losses. Thus, performance of optical modulator 2800 may be improved.

To further compensate for loss in impedance (e.g., due to an increased capacitance), the transmission line main section may contain structures, such as trenches, voids, apertures, and/or cutouts to increase the inductance per unit length of the electrode and/or to reduce the capacitance per unit length of the electrode.

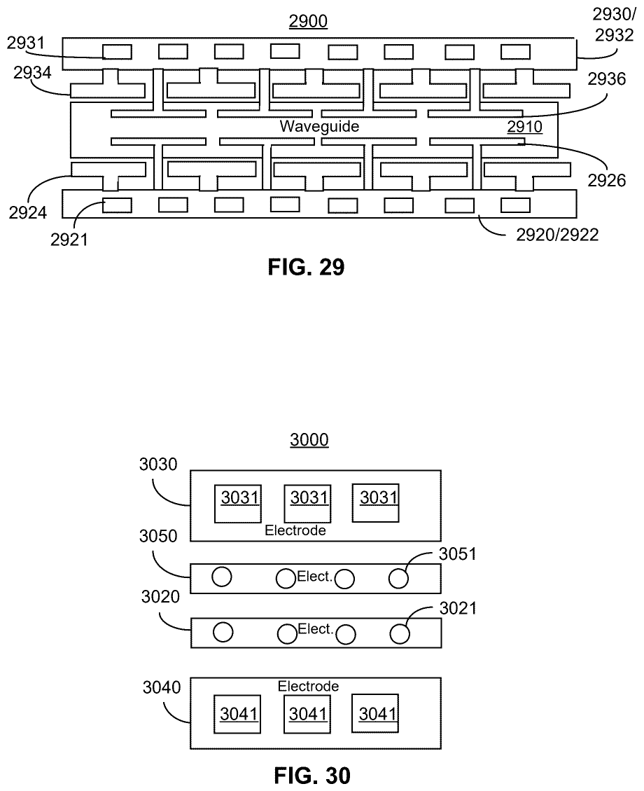

For example, FIG. 29 depicts an embodiment of a portion of TFLC electro-optic device 2900 that may have improved efficiency. FIG. 29 depicts a plan view of electro-optic device 2900. For clarity, only a portion of TFLC electro-optic device 2900 is shown. TFLC electro-optic device 2900 is analogous to TFLC electro-optic devices described herein, such as device 2800. TFLC electro-optic device 2900 includes TFLC waveguide 2910 and electrodes 2920 and 2930 that are analogous to waveguide 2810 and electrodes 2820 and 2830. Waveguide 2910 may include a ridge (not labeled) and a slab (not labeled) analogous to ridge 312 and slab 314. In other embodiments, waveguide 2910 may be a channel waveguide. Electrodes 2920 and 2930 include side extensions 2924 and 2934 and top extensions 2926 and 2936 that are analogous to side extensions 2824 and 2834 and extensions 2826 and 2836. Electrodes 2920 and 2930 also include channel regions 2922 and 2932 that are analogous to channel regions 2822 and 2832.

In addition, channel regions 2922 and 2932 includes structures 2921 and 2931 (of which only one of each is labeled). Structures 2921 and 2931 may be trenches, voids, apertures, cutouts, and/or other structures that increase the inductance per unit length of electrodes 2920 and 2930 and/or decrease the capacitance per unit length of electrodes 2920 and 2930. For example, structures 2921 and 2931 may induce a velocity mismatch in an analogous manner to extensions. Thus, a change in capacitance that would otherwise have decreased the inductance of electrodes 2920 and 2930 may be at least partially compensated for.

Similarly, FIG. 30 depicts an embodiment of a portion of TFLC electro-optic device 3000 that may have improved efficiency. FIG. 30 depicts a plan view of electro-optic device 3000. For clarity, only a portion of TFLC electro-optic device 3000 is shown. TFLC electro-optic device 3000 is analogous to TFLC electro-optic devices described herein, such as device 2900. TFLC electro-optic device 3000 includes TFLC waveguide(s) (not shown) and electrodes 3020, 3030, 3040, and 3050 that are analogous to waveguide 2910 and electrodes 2920 and 2930. However, an additional electrode 3050 is present. Electrodes 3020, 3030, 3040, and 3050 might be used in a differential configuration. Electrodes 3020, 3030, 3040, and 3050 include structures 3021, 3031, 3041 and 3051 that are analogous to structures 2921 and 2931. Structures 3021, 3031, 3041 and 3051 may be trenches, voids, apertures, cutouts, and/or other structures that increase the inductance per unit length of electrodes 3020, 3030, 3040, and 3050. Thus, a change in capacitance that would otherwise have decreased the inductance of electrodes 3020, 3030, 3040, and 3050 may be at least partially compensated for.

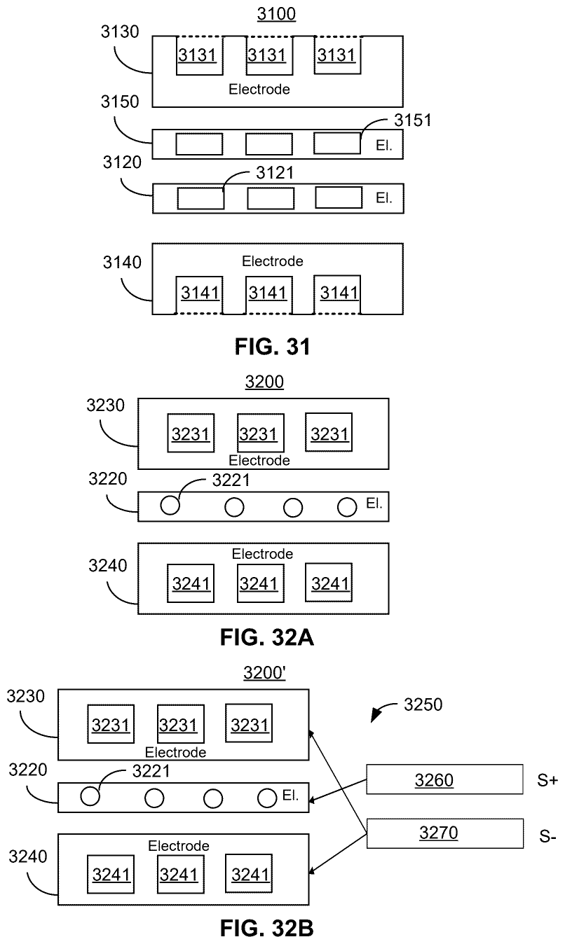

FIG. 31 depicts an embodiment of a portion of TFLC electro-optic device 3100 that may have improved efficiency. FIG. 31 depicts a plan view of electro-optic device 3100. For clarity, only a portion of TFLC electro-optic device 3100 is shown. TFLC electro-optic device 3100 is analogous to TFLC electro-optic devices described herein, such as devices 2900 and 3000. TFLC electro-optic device 3100 includes TFLC waveguide(s) (not shown) and electrodes 3120, 3130, 3140, and 3150 that are analogous to waveguide 2910 and electrodes 2920 and 2930. Electrodes 3120, 3130, 3140, and 3150 are also analogous to electrodes 3020, 3030, 3040, and 3050. Electrodes 3120, 3130, 3140, and 3150 might be used in a differential configuration. Electrodes 3120, 3130, 3140, and 3150 include structures 3121, 3131, 3141 and 3151 that are analogous to structures 2921 and 2931 and to structures 3021, 3031, 3041 and 3051. Structures 3121, 3131, 3141 and 3151 may be trenches, voids, apertures, cutouts, and/or other structures that increase the inductance per unit length of electrodes 3120, 3130, 3140, and 3150. For example, structures 3141 and 3131 may be cutouts (indicated by the dotted line). Electrodes 3130 and 3140 may thus have features that are similar to extensions. Electrodes 3120, 3130, 3140, and 3150 have a tailored inductance. Thus, a change in capacitance that would otherwise have decreased the inductance of electrodes 3120, 3130, 3140, and 3150 may be at least partially compensated for.

Optical device having the characteristics described herein may also be coupled to other devices. For example, FIGS. 32A and 32B depict embodiments of a portion of TFLC electro-optic devices 3200 and 3200′ that may have improved efficiency. FIG. 32A depicts a plan view of electro-optic device 3200. FIG. 32B depicts a plan view of optical device 3200′. For clarity, only a portion of TFLC electro-optic devices 3200 and 3200′ are shown. TFLC electro-optic devices 3200 and 3200′ are analogous to TFLC electro-optic devices described herein, such as device 2900. TFLC electro-optic device 3200 includes TFLC waveguide(s) (not shown) and electrodes 3220, 3230, and 3240 that are analogous to waveguide 2910 and electrodes 2920 and 2930. Electrodes 3220, 3230, and 3240 include structures 3221, 3231, and 3241 that are analogous to structures 2921 and 2931. Structures 3221, 3231 and 3241 may be trenches, voids, apertures, cutouts, and/or other structures that increase the inductance per unit length of electrodes 3220, 3230, and 3240. Thus, a change in capacitance that would otherwise have decreased the inductance of electrodes 2920 and 2930 may be at least partially compensated for.

Optical device 3200′ is analogous to optical device 3200 but includes or is coupled to balun 3250. Balun may be considered to connect differential electrodes 3260 and 3270 to the single ended system of electrodes 3220, 3230, and 3240. Thus, a portion of differential electrodes 3260 and 3270 (or balun 3250) may be oriented vertically (e.g. perpendicular to the surface of the substrate. Differential electrodes 3260 and 3270 may create a mode in between the vertical layers. The transmission lines 3230 and may include structures described herein. For example, structures 3221, 3231 and 3241 (e.g., apertures, trenches, and/or voids) may be present.

Thus, tailoring the inductance and/or capacitance of electrodes 3220, 3230, and/or 3240, may be combined with the use of other devices, such as balun 3250. Other combinations are possible. For example, at least some embodiments of the electrodes described herein may be driven with a capacitor direct drive (non-traveling wave). In such embodiments, the capacitance per unit length for each electrode gap may be greater than 100 pf/m. Further, at least some embodiments may be combined with high permittivity, low-index cladding materials such as hafnium oxide to further improve V-pi-L for a given optical loss. Thus, performance may be further enhanced.

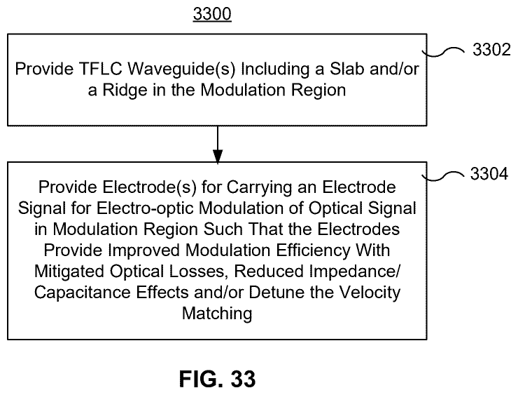

FIG. 33 is a flow chart depicting an embodiment of method 3300 for providing a TFLC electro-optic device that may have improved efficiency. Method 3300 is described in the context of processes that may have sub-processes. Although described in a particular order, another order not inconsistent with the description herein may be utilized. In addition, method 3300 is described in the context of a single device. In general, multiple devices are fabricated together. Method 3300 is also described in the context of TFLC device 100. However, method 3300 may be used with other devices. Method 3300 may be considered a process for providing an optical modulator for an optical device.

A method for providing an electro-optic device is described. The method includes providing an optical modulator. Providing the optical modulator includes providing a waveguide and providing electrodes. The waveguide includes TFLC material(s). The waveguide also includes a ridge and/or a slab in at least a modulation region. A portion of the electrodes are proximate to a portion of the waveguide in the modulation region. Moreover, providing the optical modulator includes configuring the optical modulator such that at least one of an electrode has at least one contour such that a first portion of the electrode is proximate to a sidewall and a second portion of the electrode is proximate to a top surface of the ridge and/or the slab, at least a portion of the electrode includes a transparent conductive material, and/or the optical modulator is configured such that a velocity match between an electrode signal speed of an electrode signal in the electrode and an optical speed of an optical signal in the waveguide is detuned to provide a velocity mismatch.

A TFLC waveguide is provided, at 3302. In some embodiments, 3302 includes performing one or more etches to define the waveguide in the modulation region as well as other areas of the optical device. For example, bend regions, modulation regions, splitters, combiners, and other optical components may be formed.

At 3304, the electrode(s) are provided. The electrode(s) may be configured to carry an electrode signal (e.g., a single ended signal, a differential signal, a traveling wave signal, a non-traveling wave signal, and/or another type of signal) as part of 3304. In addition, the geometry and materials for the electrodes are configured at 3304 to mitigate losses and improve modulation efficiency. For example, the electrodes may be placed closer together (smaller seg_g, for example) to improve the modulation efficiency, but configured with multiple separations (e.g. including side regions, capping regions, and/or bottom regions in addition to top regions), using TCM(s) for at least part of the electrode, or fabricating geometry that would have a detuned velocity match with the optical signal in the frequency range the optical modulator is to be used at, particularly over short modulator lengths. Further, the waveguide bend regions may be configured to mitigate phase mismatches induced by the velocity mismatch in the modulation region. Thus, optical modulator(s) may have increased modulation efficiency without unduly sacrificing other aspects of performance.

For example, at 3302 waveguide 110 of device 100 may be fabricated. Thus, straight modulation regions 113 and bend regions 111 are formed. At 3304 electrodes 120, 130, and 140 are formed. In some embodiments, 3302 and 3304 combine to provide optical device 100 with the desired components. In another example, waveguide 310 of device 300 may be provided at 3302. At 3304, side regions 324 and 334 and top regions 325 and 335 are formed. Similarly, at 3302 waveguides 1510 may be formed. At 3304, channel regions 1522, 1532, and 1542 as well as extensions 1526 and 1546. Thus, the benefits of various devices described herein may be achieved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An electro-optic device, comprising:
an optical modulator including
a waveguide including at least one thin film lithium-containing (TFLC) material, the waveguide including at least one of a ridge and a slab in at least a modulation region; and
a plurality of electrodes, a portion of the plurality of electrodes being proximate to a portion of the waveguide in the modulation region;
wherein at least one of an electrode of the plurality of electrodes has at least one contour such that a first portion of the electrode is proximate to a sidewall and a second portion of the electrode is proximate to a top surface of at least one of the ridge or the slab, at least a portion of the electrode includes a transparent conductive material, or the optical modulator is configured such that a velocity match between an electrode signal speed of an electrode signal in the electrode and an optical speed of an optical signal in the waveguide is detuned to provide a velocity mismatch.

2. The electro-optic device of claim 1, wherein the sidewall is a slab sidewall of the slab and the top surface is a slab top surface of the slab, the electrode further including a third portion proximate to a ridge top surface of the ridge.

3. The electro-optic device of claim 1, wherein the electrode further includes a bottom portion extending under the slab.

4. The electro-optic device of claim 3, wherein the bottom portion is connected to the first portion and the second portion by at least one of a conductive via, a channel portion of the electrode further from the waveguide, or a direct connection of the bottom portion.

5. The electro-optic device of claim 1, wherein the portion of the electrode includes the transparent conductive material having a dielectric constant greater than a cladding dielectric constant.

6. The electro-optic device of claim 1, wherein the plurality of electrodes includes a plurality of extensions coupled with a plurality of channel regions.

7. The electro-optic device of claim 6, wherein the plurality of extensions consists of the transparent conductive material.

8. The electro-optic device of claim 6, wherein the electrode includes a portion of the plurality of extensions, the first portion and the second portion of the electrode having a configuration selected from coupled to the portion of the plurality of extensions and included in the portion of the plurality of extensions.

9. The electro-optic device of claim 1, wherein the slab includes a trench therein.

10. The electro-optic device of claim 1, wherein the optical modulator has a V-pi-L of not more than 2 V-cm and a length of not more than 5 millimeters.

11. The electro-optic device of claim 1, wherein the plurality of electrodes includes a plurality of apertures therein.

12. The electro-optic device of claim 1, wherein the plurality of electrodes includes an electrode pair, and wherein the electrode pair has a capacitance of at least 10 pF/m and not more than 90 pF/m for a gap of the electrode pair and an impedance of at least 20 Ohms and not more than 80 Ohms.

13. The electro-optic device of claim 1, wherein the waveguide is configured such that the velocity mismatch is at least one percent and not more than fifty percent.

14. The electro-optic device of claim 13, wherein the velocity mismatch is at least five percent.

15. The electro-optic device of claim 13, wherein the modulation region has a length of not more than five millimeters.

16. An optical modulator, comprising:
a waveguide including at least one thin film lithium-containing (TFLC) material, the waveguide including at least one of a ridge and a slab in at least a modulation region; and
a plurality of electrodes, a portion of the plurality of electrodes being proximate to a portion of the waveguide in the modulation region;
wherein at least one of an electrode of the plurality of electrodes has at least one contour such that a first portion of the electrode is proximate to a sidewall and a second portion of the electrode is proximate to a top surface of at least one of the ridge or the slab, at least a portion of the electrode includes a transparent conductive material, or the optical modulator is configured such that a velocity match between an electrode signal speed of an electrode signal in the electrode and an optical speed of an optical signal in the waveguide is detuned to provide a velocity mismatch.

17. The optical modulator of claim 16, wherein the electrode includes a bottom portion extending under the slab.

18. The optical modulator of claim 16, wherein the at least the portion of the electrode includes the transparent conductive material and wherein the transparent conductive material has a dielectric constant greater than a cladding dielectric constant.

19. The optical modulator of claim 16, wherein the optical modulator is configured such that the velocity match between the electrode signal speed and the optical speed is detuned to provide the velocity mismatch of at least five percent and not more than fifty percent and the modulation region has a length of not more than five millimeters.

20. A method for providing an electro-optic device, comprising:
providing an optical modulator, the providing the optical modulator further including
providing a waveguide, the waveguide including at least one thin film lithium-containing (TFLC) material, the waveguide including at least one of a ridge and a slab in at least a modulation region; and
providing a plurality of electrodes, a portion of the plurality of electrodes being proximate to a portion of the waveguide in the modulation region;
wherein at least one of an electrode of the plurality of electrodes has at least one contour such that a first portion of the electrode is proximate to a sidewall and a second portion of the electrode is proximate to a top surface of at least one of the ridge or the slab, at least a portion of the electrode includes a transparent conductive material, or the optical modulator is configured such that a velocity match between an electrode signal speed of an electrode signal in the electrode and an optical speed of an optical signal in the waveguide is detuned to provide a velocity mismatch.
